(19) United States
(12) Patent Application Publication
(10) Pub. No.: US 2023/0325827 A1
(43) Pub. Date: Oct. 12, 2023

(54) INFORMATION PROCESSING APPARATUS, PROGRAM, METHOD AND TERMINAL

(71) Applicant: LINE Corporation, Tokyo (JP)

(72) Inventor: Yusuke YONEYAMA, Tokyo (JP)

(21) Appl. No.: 18/299,362

(22) Filed: Apr. 12, 2023

Related U.S. Application Data
(63) Continuation of application No. PCT/JP2021/039691, filed on Oct. 27, 2021.

(30) Foreign Application Priority Data
Oct. 27, 2020 (JP) 2020-181739

(51) Int. Cl. G06Q 20/38; G06Q 20/40

(52) U.S. Cl. CPC G06Q 20/389; G06Q 20/382; G06Q 20/401

(57) ABSTRACT

An information processing apparatus including at least one processor configured to perform a first process for associating first information for a user of a terminal to obtain a cryptographic asset with identification information of the user, and a second process for associating the cryptographic asset based on the first information with the identification information of the user, based on verification with respect to the user may be provided.

### CROSS-REFERENCE TO RELATED APPLICATIONS

This U.S. non-provisional application is a continuation of and claims the benefit of priority under 35 U.S.C. § 365(c) to International Application PCT/JP2021/39691, which has an International filing date of Oct. 27, 2021 and claims priority to Japanese Patent Application No. JP2020-0181739, filed Oct. 29, 2020, the entire contents of each of which are incorporated herein by reference in their entirety.

### BACKGROUND

### Technical Field

The present disclosure relates to information processing apparatuses, programs, methods and/or terminals.

### Description of Related Art

A transaction management apparatus may use a blockchain to manage blocks that store information on each step in a credit guarantee procedure between a purchaser and an intermediary and/or information on each step in a credit guarantee procedure between the intermediary and a seller.

### SUMMARY

According to an example embodiment of the present disclosure, an information processing apparatus includes at least one processor configured to perform a first process for associating first information for a user of a terminal to obtain a cryptographic asset with identification information of the user and a second process for associating the cryptographic asset with the identification information of the user based on verification with respect to the user.

According to an example embodiment of the present disclosure, there is provided a non-transitory computer-readable medium storing instructions thereon, which when executed by at least one processor, cause an information processing apparatus to perform a process, which includes a first process for associating first information for a user of a terminal to obtain a cryptographic asset with identification information of the user and a second process for associating the cryptographic asset with the identification information of the user based on verification with respect to the user.

According to an example embodiment of the present disclosure, an information processing method of an information processing apparatus includes performing a first process for associating first information for a user of a terminal to obtain a cryptographic asset with identification information of the user and performing a second process for associating the cryptographic asset with the identification information of the user based on verification with respect to the user.

According to an example embodiment of the present disclosure, there is provided a non-transitory computer-readable medium storing instructions thereon, which when executed by at least one processor, cause a terminal to perform a process, which includes displaying first display information on a display of the terminal based on associating first information for a user of the terminal to obtain a cryptographic asset with identification information of the user, and displaying, in response to verification with respect to the user, on the display of the terminal, second display information based on associating the cryptographic asset with the identification information of the user.

According to a fifth embodiment of the present disclosure, an information displaying method of a terminal includes displaying first display information on a display of the terminal based on associating first information for a user of the terminal to obtain a cryptographic asset with identification information of the user, and displaying, in response to verification with respect to the user, second display information on the display of the terminal based on associating the cryptographic asset with the identification information of the user.

According to a sixth embodiment of the present disclosure, a terminal includes a processor configured to control a display that is configured to display first display information based on associating first information for a user of the terminal to obtain a cryptographic asset with identification information of the user and, in response to verification with respect to the user, second display information based on associating the cryptographic asset with the identification information of the user.

### BRIEF DESCRIPTION OF DRAWINGS

FIG. 1 is a diagram illustrating one example of a system configuration of a communication system according to an example embodiment.

FIG. 2 is a diagram illustrating one example of a hardware configuration of an exchange server according to an example embodiment.

FIG. 3 is a diagram illustrating one example of a hardware configuration of a gift distribution server according to an example embodiment.

FIG. 4 is a configuration diagram of blockchain according to an example embodiment.

FIG. 5 is a conceptual diagram of processes according to an example embodiment.

FIGS. 6 and 7 are flowcharts showing one example of a flow of processes performed by each apparatus according to an example embodiment.

FIGS. 8A to 8F show diagrams illustrating one example of a screen displayed on a display unit of a terminal according to an example embodiment.

FIGS. 9 and 10 are flowcharts showing one example of a flow of processes performed by each apparatus according to an example embodiment.

FIGS. 11 and 12 are flowcharts showing one example of a flow of processes performed by each apparatus according to an example embodiment.

### DETAILED DESCRIPTION

<Compliance with Legal Matters>

It should be noted that the disclosures contained herein are subject to compliance with the legal matters of the implementing country necessary for the implementation of the disclosures, including the confidentiality of communications.

Some example embodiments for implementing a program and the like according to the present disclosure will be described with reference to figures.

In the description, the expression “by means of a(the) communication I/F” is used as appropriate. This indicates that, as an example, not as a limitation, an apparatus sends and receives various types of information and data via the communication I/F (through a communication unit) based on the control of a control unit (processor, etc.).

Further, in the followings, as an example, not as a limitation, it is assumed that various processes according to the disclosed example embodiments are performed by applications (as an example, not as a limitation, a gift application, a token application, and/or a cryptographic asset application) installed on the terminal.

Further, as an example, not as a limitation, it is possible to have a function of a chat service (as an example, not as a limitation, a messaging service) as one function of the token application and/or the gift application, or to have a function of a chat application (as an example, not as a limitation, a messaging application) as one function of the token application service and/or the gift application service. In addition, the token application can also be described as a wallet service application or a digital asset management application.

The messaging service is configured so that a user can chat using a chat room.

In the following descriptions, a UI (User Interface) or a GUI (Graphical User Interface) that allows each user to view a content sent and received between multiple user terminals is referred to as a “talk room” as appropriate. A talk room may also be referred to as a chat room.

The content may include not only a message containing simple text, a pictogram, etc., but also other information that can be sent and received between terminals such as, as an example, not as a limitation, image information (including information such as a still image, a moving image, etc.), operation information (including buttons, icons, etc.), information for communication, link information (including a URI, a URL, etc.), and the like.

Further, the talk room may include not only a one-to-one user talk room, but also, as an example, not as a limitation, one for a group that includes multiple users (a group talk room). A talk room in this case refers to a UI or a GUI that allows users in a group to view the content sent and received between each terminal in the group that includes multiple users.

Further, the messaging service may include Instant Messaging Service (IMS), which enables the sending and receiving of content such as simple messages and the like between terminals.

Further, the messaging service MS (including IMS) may be considered as one form (one example embodiment) of social networking service SNS.

Therefore, the messaging service MS and social networking service SNS may be distinguished.

Further, in the following, an input to the terminal is mainly, but not limited to, an operational input by the terminal user (input by touch (touch operation) as an example, not as a limitation).

In the following descriptions, an “issuing entity” is, as an example, not as a limitation, an entity that provides a service related to the provision of a “cryptographic asset exchange token” that enables the acquisition of a cryptographic asset to the user of the terminal. In addition, it is also an example, not a limitation, the issuing entity is an entity that provides a service related to the provision of a cryptographic asset based on a cryptographic asset exchange token to the user of the terminal. As an example, not a limitation, the issuing entity is an issuer (molder) of a desired (or alternatively, predetermined) cryptographic asset to be provided.

Here, the “cryptographic asset exchange token” may simply be referred to as a “token”.

Further, in the following description, an “exchange operator” is an example, not a limitation, of an entity that provides (e.g., transfers) a desired (or alternatively, predetermined) cryptographic asset to a terminal user in response to a request by the terminal user or the issuing entity. Here, providing a desired (or alternatively, predetermined) cryptographic asset includes, as an example, not as a limitation, providing a cryptographic asset of a value corresponding to a purchase amount (as an example, not as a limitation, a used amount (invested amount) of legal tender including electronic money or a used amount of points) of the cryptographic asset by the terminal user. Also, providing a desired (or alternatively, predetermined) cryptographic asset includes, as an example, not as a limitation, providing a cryptographic asset of a value corresponding to a cryptographic asset exchange token used by the terminal user. The exchange operator may be a business operator registered with a competent fiscal authority, as a cryptographic asset exchange operator.

The exchange operator determines, as an example, not as a limitation, an exchange rate (conversion rate) between a legal tender and a cryptographic asset. The exchange rate is a value that changes depending on the demand for the cryptographic asset.

The exchange operator provides, as an example, not as a limitation, a token application service and a cryptographic asset application service to the terminal.

Further, in the following description, a “distribution provider” is, as an example, not as a limitation, an entity that provides terminal users with information that enables them to obtain a cryptographic asset exchange token. The distribution provider sends, as an example, not as a limitation, promotional gift information and the like, to the user terminal as information that enables the user to obtain a cryptographic asset exchange token in response to a request from the issuing entity.

Further, in the following description, “legal tender” includes, as an example, not as a limitation, legal tender such as the yen, US dollar, yuan, euro, won, and the like. “Legal tender” may include, as an example, not as a limitation, electronic money. Also, “legal tender” may include, as an example, not as a limitation, cryptocurrencies (virtual currencies).

Further, in the following description, a “cryptographic asset” includes, as an example, not as a limitation, a cryptographic asset (cryptocurrencies and virtual currencies) managed by a blockchain, such as Bitcoin (registered trademark), Bitcoin Cash, Ethereum (registered trademark), Tether (registered trademark), Litecoin (registered trademark), Link, and Monacoin (registered trademark). In addition, “cryptographic asset” may be an asset that a user can obtain (exchange or purchase) from a cryptographic asset exchanger. In the description, a cryptographic asset other than legal tender is referred to as a cryptographic asset.

Further, the issuance (which may be, without limitation, activation) and use (which may be, without limitation, deactivation or payment) of a cryptographic asset exchange token may be managed in “token blockchain”.

Also, the remittance (which may be, without limitation, provision or grant) of a cryptographic asset may be managed in “cryptographic asset blockchain”.

### First Example Embodiment

The first example embodiment is an example embodiment for receiving a cryptographic asset from the issuing entity, in which, as an example, not as a limitation, after the distribution provider and the issuing entity conclude a contract for the distribution of cryptographic assets, the user receives a gift from the distribution provider with which a cryptographic asset can be received equivalent to a desired (or alternatively, predetermined) amount in terms of legal currency (legal tender). Then, by receiving (redeeming) the gift, the user receives the cryptographic asset.

The contents described in the first example embodiment are applicable to other example embodiments and variations thereof.

In addition, the same components as those already described will be marked with the same symbols and the description thereof will be omitted.

### <System Configuration>

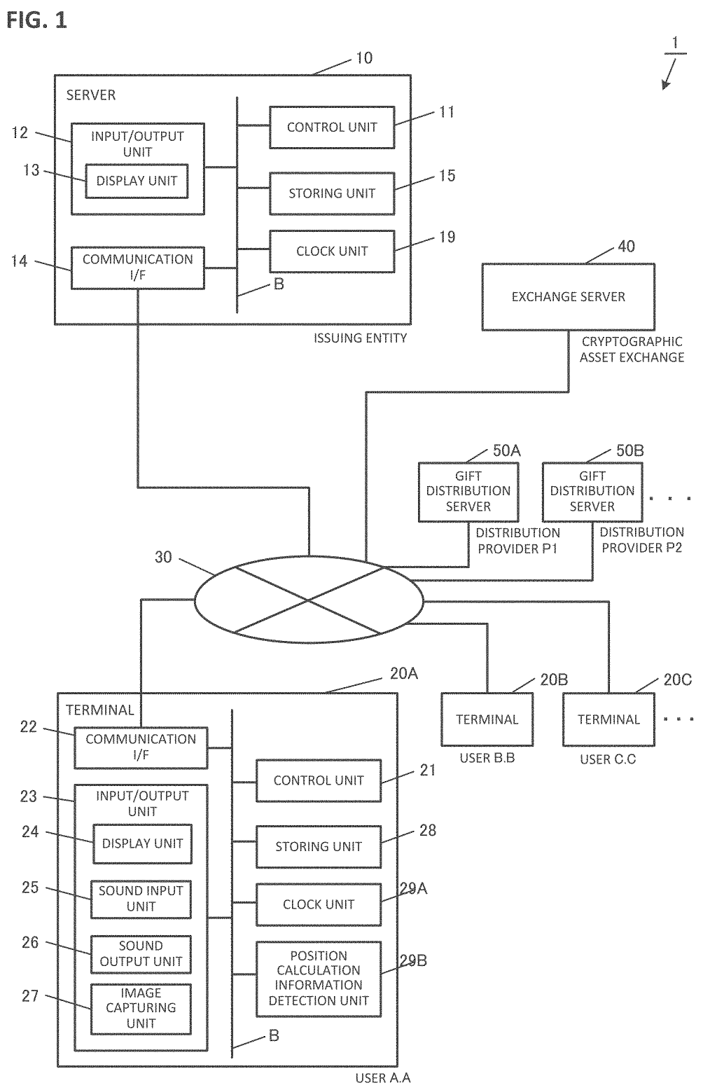

FIG. 1 is a diagram illustrating one example of a system configuration of a communication system 1 according to an example embodiment.

In the communication system 1, as an example, not as a limitation, a server 10, a plurality of terminals 20 (e.g., terminals 20A, 20B, 20C, . . . ), an exchange server 40, and a plurality of gift distribution servers 50 (gift distribution server 50A, gift distribution server 50B, . . . ) are connected via network 30.

The server 10 has a function of providing a service using the token blockchain and cryptographic asset blockchain via the network 30. The server 10 can be described as an issuing entity server, a token issuing service server, a cryptographic asset issuing service server, or the like. In the present example embodiment, as an example, not as a limitation, a user of the server 10 is a token issuer (a token issuing entity and a token issuing service provider) and a cryptographic asset issuer (a cryptographic asset issuing entity and a cryptographic asset issuing service provider).

The number of the servers 10 connected to the network 30 is not limited. As an example, not as a limitation, one or more server(s) 10 may be connected.

The exchange server 40 has a function to provide a cryptographic asset transaction (exchange) service using the cryptographic asset blockchain via the network 30. The exchange server 40 can be described as a cryptographic asset exchange server, a cryptographic asset exchanging server, a cryptographic asset transaction server, or the like. The exchange server 40 may also be described as a messaging server, a messaging service server, or the like. In the present example embodiment, as an example, not as a limitation, a user of the exchange server 40 is a cryptographic asset exchanger (a cryptographic asset trader).

The number of the exchange servers 40 connected to the network 30 is not limited. As an example, not a limitation, one or more exchange server(s) 40 may be connected.

The gift distribution server 50 has a function to provide a gift distribution service that distributes (issues) via network 30, a gift based on a promotional service, or the like. The gift distribution server 50 may be described as a gift application management server, a gift service server, a distribution service server, a gift distribution service server, or the like. The gift distribution server 50 may also be described as a messaging server, a messaging service server, or the like. In the present example embodiment, as an example, not a limitation, a user of the gift distribution server 50 is a promotion service provider.

The number of the gift distribution servers 50 connected to the network 30 is not limited. As an example, not as a limitation, one gift distribution server 50 may be connected.

The terminal 20 (terminal 20A, terminal 20B, terminal 20C, . . . ) may be any information processing terminal capable of performing the functions described in each example embodiment. The terminal 20 may be, as an example, not as a limitation, a smartphone, a cellular phone (feature phone), a computer (as an example, not as a limitation, desktop, laptop, tablet, and the like), a media computer platform (as an example, not as a limitation, cable, satellite set-top box, digital video recorder), a handheld computing device (as an example, not as a limitation, PDA (personal digital assistants), e-mail client, and the like), a wearable device (eyeglass-type device, watch-type device, and the like), a VR (Virtual Reality) terminal, a smart speaker (voice recognition device), or other types of computers or communication platforms. The terminal 20 may also be described as an information processing terminal.

The number of the terminals 20 connected to the network 30 is not limited.

The configurations of the terminal 20A, the terminal 20B and the terminal 20C may be, as an example, not as a limitation, identical. If desired, a terminal used by a user X may be described as a terminal 20X, and user information in a desired (or alternatively, predetermined) service associated with the user X or the terminal 20X may be described as user information X.

The user information is information of a user associated with an account (e.g., blockchain wallet address) used by the user in a desired (or alternatively, predetermined) service. The user information includes, as an example, not as a limitation, information associated with the user, such as a name of the user, an icon image, an age, a gender, an address, an interest, an identifier, and the like, entered by the user or assigned by the desired (or alternatively, predetermined) service, and may be any one or a combination of these information.

The network 30 carries out a role for connecting one or more terminal(s) 20, one or more server(s) 10, one or more exchange server(s) 40, and one or more gift distribution server(s) 50 with each other. In other words, network 30 refers to a communication network that provides a connection path so that the various apparatuses mentioned above can send and receive data after the connection is made among them.

The network 30 may also connect, in addition to the above, though not shown in the figures, information processing apparatuses (servers, terminals, etc.) that function as nodes of the token blockchain and the cryptographic asset blockchain, respectively.

One or more parts of the network 30 may be a wired or wireless network. The network 30 may include, as an example, not as a limitation, ad hoc network, intranet, extranet, virtual private network (VPN), local area networks (LAN), wireless LAN (WLAN), wide area network (WAN), wireless WAN (WWAN), metropolitan area network (MAN), part of the Internet, part of the Public Switched Telephone Network (PSTN), cellular telephone network, integrated service digital networks (ISDN), wireless LAN, LTE (long term evolution), CDMA (code division multiple access), Bluetooth (registered trademark), satellite communication, or a combination of two or more of these. The network 30 can include one or more network(s) 30.

The server 10 (not a limitation, an example of server, information processing apparatus, or information management apparatus) has a function to provide the exchange server 40 and/or the gift distribution server 50 with a desired (or alternatively, predetermined) service (in the present example embodiment, a service relating to token issuance (transaction transmission) by the token blockchain and the cryptographic asset blockchain). The server 10 may be any information processing apparatus capable of performing the functions described in each example embodiment. The server 10 may be, as an example, not as a limitation, a server apparatus, a computer (as an example, not as a limitation, desktop, laptop, or tablet), a media computer platform (as an example, not as a limitation, cable, satellite set-top box, or digital video recorder), a handheld computer device (as an example, not a limitation, PDA, e-mail client), or other types of computers or communication platforms. The server 10 may also be described as an information processing apparatus. The server 10 and the exchange server 40 and/or the gift distribution server 50 each may be described as an information processing apparatus, respectively, when there is no need to distinguish between the server 10 and the exchange server 40 and/or the gift distribution server 50.

When there is no need to distinguish between the server 10 and the terminal 20, the server 10 and the terminal 20 may be described as an information processing apparatus, respectively.

The exchange server 40 (not as a limitation, as an example of server, information processing apparatus, or information management apparatus) has a function to provide a desired (or alternatively, predetermined) service (in the present example embodiment, a service related to the token blockchain and cryptographic asset blockchain) to the terminal 20 and/or the server 10. The exchange server 40 may be any information processing apparatus capable of performing the functions described in each embodiment. The exchange server 40 may be, as an example, not as a limitation, a server apparatus, a computer (as an example, not a limitation, desktop, laptop, or tablet), a media computer platform (as an example, not as a limitation, cable, satellite set-top box, or digital video recorder), a handheld computer devices (as an example, not as a limitation, PDA, email client), or other types of computers or communication platforms. The exchange server 40 may also be described as an information processing apparatus. When there is no need to distinguish between the exchange server 40 and the server 10 and/or the terminal 20, the exchange server 40 and the server 10 and/or the terminal 20 each may be described as an information processing apparatus, respectively.

The gift distribution server 50 (not as a limitation, an example of server, information processing apparatus, or information management apparatus) has a function to provide a desired (or alternatively, predetermined) service (in the present example embodiment, a service related to a cryptographic asset gift) to the terminal 20 and/or the server 10. The gift distribution server 50 may be any information processing apparatus capable of performing the functions described in each example embodiment. The gift distribution server 50 may be, as an example, not a limitation, a server apparatus, a computer (as an example, not as a limitation, desktop, laptop, or tablet), a media computer platform (as an example, not a limitation, cable, satellite set-top box, or digital video recorder), a handheld computer devices (as an example, not as a limitation, PDA, or email client), or other types of computers or communication platforms. The gift distribution server 50 may also be described as an information processing apparatus. When there is no need to distinguish between the gift distribution server 50 and the server 10 and/or the terminal 20, the gift distribution server 50 and the server 10 and/or the terminal 20 each may be described as an information processing apparatus, respectively.

### <Hardware (HW) Configurations of Each Apparatus>

HW configurations of each apparatus included in the communication system 1 will be described.

### (1) HW Configuration of Terminal

FIG. 1 illustrates an example of a HW configuration of the terminal 20. The terminal 20 comprises a control unit 21 (CPU: central processing unit), a storing unit 28, a communication I/F 22 (interface), an input/output unit 23, a clock unit 29A, and a position calculation information detection unit 29B. Each component of HW of the terminal 20 is, as an example, not as a limitation, interconnected via a bus B. Here, it is not desired to include all the components as the HW configuration of the terminal 20. As an example, not as a limitation, the terminal 20 may be configured such that an individual component or multiple components are removed.

The communication I/F 22 sends and receives various types of data via the network 30. The communication may be performed by either wired or wireless means, and any communication protocol may be used as long as communication with each other can be performed. The communication I/F 22 has a function to perform communication with various apparatuses, such as the server 10 and the like, via the network 30. The communication I/F 22 sends various data to various apparatuses such as the server 10 and the like according to instructions from the control unit 21. The communication/F 22 also receives various data sent from various apparatuses such as the server 10 and the like and sends the data to the control unit 21. In some cases, the communication I/F 22 may just be described as a communication unit. When the communication I/F 22 is composed of a physically structured circuit, it may also be described as a communication circuit.

The input/output unit 23 includes a device for inputting various operations to the terminal 20 and a device for outputting a processing result processed by the terminal 20, and the like. The input/output unit 23 may be an integration of an input unit and an output unit, or may be separated into an input unit and an output unit.

The input unit is realized by any or a combination of all types of devices capable of accepting an input from a user and sending information pertaining to the input to the control unit 21. The input unit includes, as an example, not as a limitation, a hardware key such as touch panel, touch display, keyboard and the like, a pointing device such as mouse, camera (operation input via moving images), and a microphone (operation input via voice).

The output unit is realized by any or a combination of all types of devices capable of outputting a processing result processed by the control unit 21. The output unit includes, as an example, not as a limitation, touch panel, touch display, speaker (audio output), lens (as an example, not as a limitation, 3D (three dimensions) output or hologram output), printer, and the like.

As an example, not as a limitation, the input/output unit 23 comprises a display unit 24, a sound input unit 25, a sound output unit 26, and an image capturing unit 27.

The display unit 24 is realized by any one or a combination of all types of devices capable of displaying according to display data written to the frame buffer. The display unit 24 may be, as an example, not as a limitation, a touch panel, touch display, monitor (as an example, not as a limitation, liquid crystal display or OELD (organic electroluminescence display)), head mounted display (HDM), device capable of displaying an image or text information via projection mapping, hologram, or in air (which may be a vacuum). The display unit 24 may be capable of displaying display data in 3D.

The sound input unit 25 is used to input sound data (including voice data). The same applies hereinafter. The sound input unit 25 includes a microphone or the like.

The sound output unit 26 is used to output sound data. The sound output unit 26 includes a speaker or the like.

The image capturing unit 27 is used to capture image data (including still image data and moving image data. The same applies hereinafter. The image capturing unit 27 includes a camera or the like.

If the input/output unit 23 is a touch panel, the input/output unit 23 and the display unit 24 may be arranged opposite to each other in roughly the same size and shape.

The clock unit 29A is a built-in clock of the terminal 20 and outputs time information (timekeeping information). The clock unit 29A comprises, as an example, not as a limitation, a clock using a crystal oscillator, and the like. The clock unit 29A may also be described, as an example, not as a limitation, as a timekeeping unit or a time information detecting unit.

The clock unit 29A may have a clock that applies the NITZ (Network Identity and Time Zone) standard or other standards.

The position calculation information detection unit 29B detects (measures) information desired for the control unit 21 to calculate (measure) a position of its own terminal 20 (hereinafter referred to as “position calculation information”). The position calculation information detection unit 29B may be described, as an example, not as a limitation, as a position calculation sensor unit.

The position calculation information detection unit 29B includes, as an example, not as a limitation, a satellite positioning sensor (satellite positioning unit), which is a sensor or unit to calculate the position of the terminal 20 using a satellite positioning system such as GPS (Global Positioning System), an inertial measurement sensor (inertial measurement unit (IMU)), which is a sensor or unit to calculate the position of the terminal 20 using an inertial navigation system, a UWB measurement sensor (UWB measurement unit), which is a sensor or unit to calculate the position of the terminal 20 using UWB (Ultra Wide Band), and the like.

The satellite positioning unit has, as an example, not as a limitation, an RF receiver circuit that converts RF (Radio Frequency) signals including positioning satellite signals sent from a positioning satellite that are received by, though not shown in the figures, an antenna into digital signals, a baseband processing circuit that performs correlation processing and the like on the digital signals output from the RF receiver circuit to obtain positioning satellite signals, and outputs satellite orbit data, time data, and other information extracted from the positioning satellite signals as position calculation information.

The inertial measurement unit has an inertial sensor, which is a sensor that detects information desired to calculate the position of the terminal 20 by inertial navigation calculation. The inertial sensors include, as an example, not as a limitation, a 3-axis acceleration sensor and a 3-axis gyro sensor, and output the acceleration detected by the acceleration sensor and the angular velocity detected by the gyro sensor as the position calculation information.

The UWB positioning unit has, as an example, not as a limitation, an ultra-wideband RF receiver circuit that converts ultra-wideband RF (Radio Frequency) signals including ultra-wideband pulse signals for positioning sent from a positioning beacon that is received by, though not shown in the figures, an antenna, into digital signals, an ultra-wideband RF receiver circuit that calculates the relative position of the terminal 20 with respect to the positioning beacon based on the digital signals output from the ultra-wideband RF receiver circuit, and the like.

As an example, not as a limitation, the UWB measurement unit may make the terminal 20 function as a beacon for positioning by sending ultra-wideband RF signals including ultra-wideband pulse signals for positioning from the antenna.

The control unit 21 calculates, as an example, not as a limitation, the position of its own terminal 20 at regular or specific timing based on the position calculation information detected by the position calculation information detection unit 29B. The position of the terminal is referred to as “terminal position” and the calculated terminal position is referred to as “calculated terminal position”. The control unit 21 may store the calculated terminal position in the storing unit 28 calculated terminal position history data so as to associate the calculated terminal position with the date and time when the calculated terminal position is calculated.

The control unit 21 has a physically structured circuit to perform functions to be realized by the code or instructions contained in the program, and is realized by, as an example, not as a limitation, a data processing device built into the hardware. Therefore, the control unit 21 may be described as a control circuit.

The control unit 21 includes, as an example, not as a limitation, a central processing unit (CPU), a microprocessor, a processor core, a multiprocessor, an application-specific integrated circuit (ASIC), or a field programmable gate array (FPGA).

The storing unit 28 has a function to store various programs and various data required for the terminal 20 to operate. The storing unit 28 includes, as an example, not as a limitation, various storage media such as HDD (hard disk drive), SSD (solid state drive), flash memory, RAM (random access memory), ROM (read only memory), and the like. The storing unit 28 may be described as a memory.

The terminal 20 stores a program P in the storing unit 28, and by performing the program P, the control unit 21 performs the processes as each part included in the control unit 21. In other words, the program P stored in the storing unit 28 causes the terminal 20 to realize each function performed by the control unit 21. The program P may be described as a program module.

### (2) HW Configuration of the Server

FIG. 1 illustrates an example of HW configuration of the server 10. The server 10 comprises, as an example, not as a limitation, a control unit 11 (CPU), a storing unit 15, a communication I/F 14 (interface), an input/output unit 12, and a clock unit 19. Each component of the HW of the server 10 is, as an example, not as a limitation, interconnected via a bus B. the HW of the server 10 may not include all the components as a configuration of the HW of the server 10. As an example, not as a limitation, the HW of the server 10 may be configured such that an individual component or multiple components are removed.

The control unit 11 has a physically structured circuitry to perform the functions realized by the code or instructions contained in the program and is realized by, as an example, not as a limitation, a data processing unit built into the hardware.

The control unit 11 is typically a central processing unit (CPU), and may otherwise be a microprocessor, a processor core, a multiprocessor, an ASIC, or an FPGA.

In this disclosure, the control unit 11 is not limited to them.

The storing unit 15 has a function to store various programs and various data necessary for the server 10 to operate. The storing unit 15 is realized by various storage media such as HDD, SSD, flash memory, and the like. However, in this disclosure, the storing unit 15 is not limited to them. In addition, the storing unit 15 may be described as a memory.

The communication I/F 14 sends and receives various data via the network 30. The communication may be performed by either wired or wireless means, and any communication protocol may be used as long as the communication can be performed with each other. The communication I/F 14 has a function to perform communication with various apparatuses, such as the terminal 20, via the network 30. The communication IF 14 sends various data to various apparatuses such as the terminal 20 according to instructions from the control unit 11. The communication IF 14 also receives various data sent from various apparatuses such as the terminal 20 and sends the data to the control unit 11. In addition, the communication I/F 14 may be described simply as a communication unit. When the communication I/F 14 is composed of a physically structured circuit, it may also be described as a communication circuit.

The input/output unit 12 includes a device for inputting various operations to the server 10 and a device for outputting results of processes processed by the server 10. The input/output unit 12 may be an integration of an input unit and an output unit, or may be separated into an input unit and an output unit.

The input unit is realized by any or a combination of all types of devices capable of accepting input from a user and sending information pertaining to the input to the control unit 11. The input unit is typically realized by hardware keys represented by a keyboard or the like, or a pointing device such as a mouse or the like. The input unit may include, as an example, not as a limitation, a touch panel, a camera (operation input via moving images), or a microphone (operation input via voice).

The output unit is realized by any or a combination of all types of devices capable of outputting processing results processed by the control unit 11. The output unit may include, as an example, not as a limitation, a touch panel, a touch display, a speaker (sound output), a lens (as an example, not as a limitation, 3D (three dimensions) output or hologram output), a printer or the like.

As just an example, the input/output unit 12 comprises a display unit 13, as an example, not as a limitation.

The display unit 13 is realized by a display or the like. The display is typically realized as a monitor (as an example, not as a limitation, liquid crystal display or OELD (organic electroluminescence display)). The display may be a head-mounted display (HDM) or the like. Such a display may be capable of displaying display data in 3D. In this disclosure, the display is not limited to them.

The clock unit 19 is a built-in clock of the server 10 and outputs time information (timekeeping information). The clock unit 19 is composed of, as an example, not as a limitation, an RTC (Real Time Clock) as a hardware clock, a system clock or the like. The clock unit 19 can be described as, as an example, not a limitation a timekeeping unit or a time information detection unit.

### (3) HW Configuration of the Exchange Server

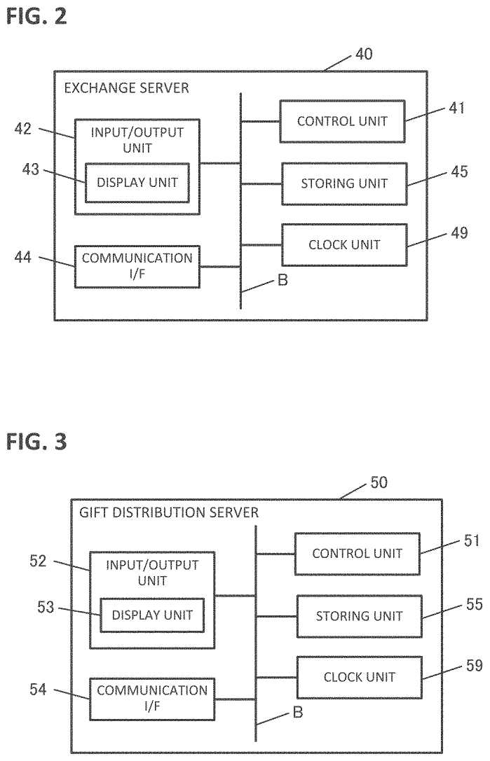

FIG. 2 illustrates an example of the HW configuration of the exchange server 40.

The exchange server 40 comprises, as an example, not as a limitation, a control unit 41 (CPU), a storing unit 45, a communication I/F 44 (interface), an input/output unit 42, and a clock unit 49. Each component of the HW of the exchange server 40 is, as an example, not as a limitation, interconnected via a bus B. The HW of the exchange server 40 may not include all the components of the HW of the exchange server 40. As an example, not a limitation, the HW of the exchange server 40 may be configured such that an individual component or multiple components are removed.

Here, the individual components of the HW of the exchange server 40 may be configured, as an example, not as a limitation, in the same way as the server 10, and therefore a detailed description thereof is omitted.

### (4) HW Configuration of the Gift Distribution Server

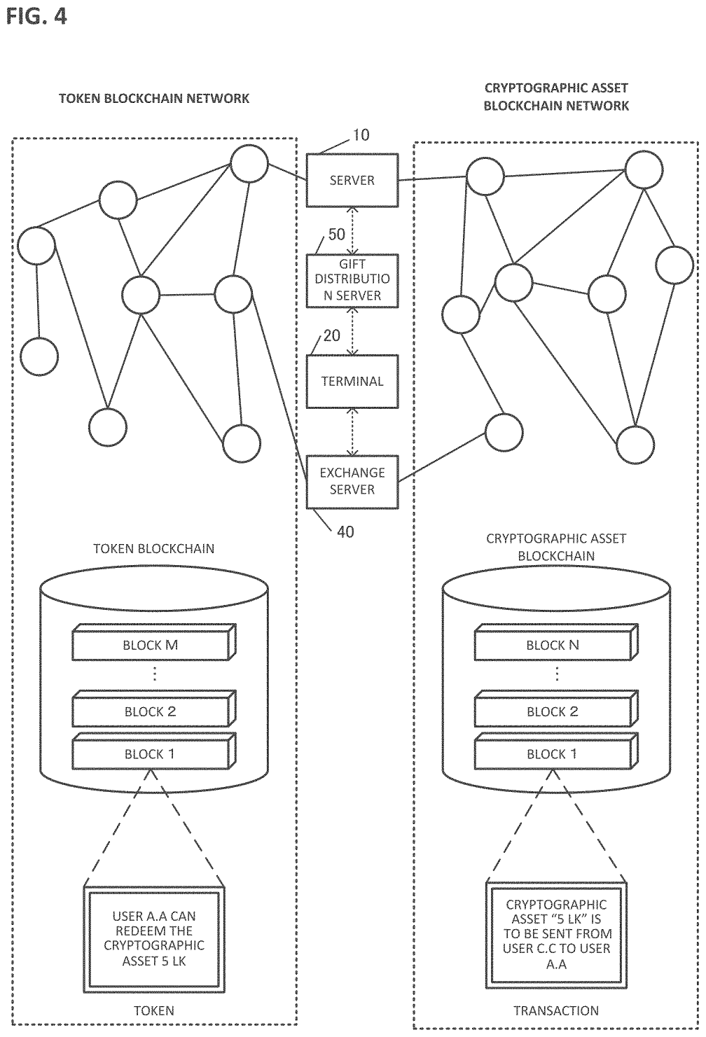

FIG. 3 illustrates an example of the HW configuration of the gift distribution server 50.

The gift distribution server 50 comprises, as an example, not a limitation, a control unit 51 (CPU), a storing unit 55, a communication I/F 54 (interface), an input/output unit 52, and a clock unit 59. Each component of the HW of the gift distribution server 50 is, as an example, not a limitation, interconnected via a bus B. The HW of the gift distribution server 50 may not include all the components of the HW of the gift distribution server 50. As an example, not a limitation, the HW of the gift distribution server 50 may be configured such that individual components or multiple components are removed.

Here, the individual components of the HW of the gift distribution server 50 may be configured, as an example, not as a limitation, in the same manner as the server 10, and therefore a detailed description thereof is omitted.

### (5) Others

The server 10 stores the program P in the storing unit 15, and by performing the program P, the control unit 11 performs processes as each part included in the control unit 11. In other words, the program P stored in the storing unit 15 causes the server 10 to realize each function performed by the control unit 11. This program P may be described as a program module. The same applies to other apparatuses.

Each example embodiment of the present disclosure is described as being realized by the CPU of the terminal 20 and/or the server 10 performing program P. The same applies to other apparatuses.

The control unit 21 of the terminal 20 and/or the control unit 11 of the server 10 may cause not only CPUs with control circuits, but also logic circuits (hardware) formed in integrated circuits (IC (Integrated Circuit) chips, LSI (Large Scale Integration)) or the like, or dedicated circuits to realize each process. Such circuits may be realized by one or more integrated circuits, and the multiple processes shown in each example embodiment may be realized by a single integrated circuit. LSIs may also be referred to as VLSI, super-LSI, ultra-LSI, etc., depending on the degree of integration. Therefore, the control unit 21 may be described as a control circuit. The same applies to other apparatuses.

Here, the program P (as an example, not as a limitation, a software program, a computer program, or a program module) of each embodiment of the present disclosure may be provided as being stored in a computer-readable storage medium. The storage medium is capable of storing the program P in a “non-transitory tangible medium”. The program P may be used to realize some of the functions of each example embodiment of the present disclosure. Furthermore, the program P may be the so-called difference file (difference program), which can realize the functions of each example embodiment of the present disclosure in combination with the program P that is already recorded in the storage medium.

The storage medium may include one or a plurality of semiconductor-based, or other integrated circuitry (IC) (as an example, not as a limitation, field programmable gate array (FPGA). IC for a specific application (ASIC) or the like), hard disk drive (HDD), hybrid hard drive (HHD), optical disk, optical disk drive (ODD), magneto-optical disk, magneto-optical drive, floppy diskette, floppy disk drive (FDD), magnetic tape, solid state drive (SSD), RAM drive, secure digital card, or drive, any other suitable storage medium, or a suitable combination of two or more of these. The storage medium may be volatile, nonvolatile, or a combination of volatile and nonvolatile, where appropriate. The storage medium is not limited to these examples and can be any device or medium capable of storing the program P. The storage medium may be described as a memory.

The server 10 and/or the terminal 20 can realize the functions of the plurality of functional parts described in each example embodiment by reading the program P stored in the memory medium and performing the read-out program P. The same applies to other apparatuses.

The program P of the present disclosure may be provided to the server 10 and/or the terminal 20 via any transmission medium capable of sending a program (communication network, broadcast wave, etc.). The server 10 and/or the terminal 20, as an example, not as a limitation, realizes the functions of the plurality of functional parts described in each example embodiment by performing the program P downloaded via the Internet or the like. The same applies to other apparatuses.

In addition, each example embodiment of the present disclosure may also be realized in the form of a data signal in which the program P is embodied by electronic transmission.

At least part of the processes at the server 10 and/or the terminal 20 may be realized by cloud computing comprising one or more computers.

At least part or all of the processes at the terminal 20 may be configured to be performed by the server 10 and/or the exchange server 40 and/or the gift distribution server 50. In this case, at least some or all of the processes of each functional part of the control unit 21 of the terminal 20 may be configured to be performed by the server 10 and/or the exchange server 40 and/or the gift distribution server 50.

At least some or all of the processes at the server 10 may be configured to be performed by the terminal 20 and/or the exchange server 40 and/or the gift distribution server 50. In this case, at least some or all of the processes of each functional part of the control unit 11 of the server 10 may be configured to be performed by the terminal 20 and/or the exchange server 40 and/or the gift distribution server 50.

At least some or all of the processes at the exchange server 40 may be configured to be performed by the server 10 and/or the terminal 20 and/or the gift distribution server 50.

At least some or all of the processes at the gift distribution server 50 may be configured to performed by the server 10 and/or the terminal 20 and/or the exchange server 40.

Although judgment is not necessarily desired, a desired (or alternatively, predetermined) process may be operated when a condition of the judgment is satisfied, or when the condition of the judgment is not satisfied.

The program of some example embodiments of the present disclosure is implemented, as an example, not a limitation, using scripting languages such as ActionScript, JavaScript (registered trademark) or the like, compiler languages such as Objective-C, Java (registered trademark) or the like, or markup languages such as HTML5 or the like.

The program of some example embodiments of the present disclosure may be implemented as a Dapps (Decentralized Applications: autonomous distributed applications) program.

### [Composition of Each Blockchain]

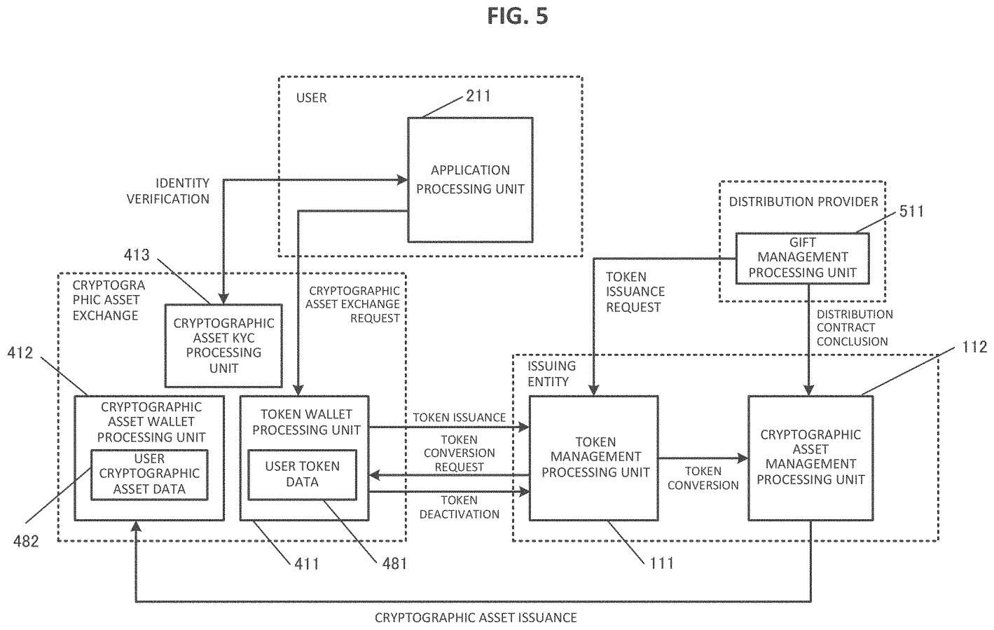

FIG. 4 illustrates an example of each blockchain in an example embodiment. In the present example embodiment, the blockchain is broadly divided into a token blockchain for storing tokens and a cryptographic asset blockchain for storing transaction information (transactions) of a cryptographic asset.

A token blockchain network that functions to store a token blockchain is composed of, as an example, not as a limitation, connections between nodes, indicated by white circles. Each node is, though not shown in the figures, a server or, though not shown in the figures, a terminal, and the like (information processing apparatuses).

In this figure, the types of nodes that make up the token blockchain network are not distinguished. The types of nodes include, as an example, not as a limitation, full nodes, lightweight nodes (Simplified Payment Verification (SPV) nodes), solo miners, and the like. The same applies to the cryptographic asset blockchain.

Here, the token blockchain may be a smart contract platform. The cryptographic asset blockchain may have smart contract implemented therein.

The server 10 is, as an example, not as a limitation, connected to the token blockchain network and the cryptographic asset blockchain network as a full node of the token blockchain and the cryptographic asset blockchain.

The exchange server 40 is, as an example, not as a limitation, connected to the token blockchain network and the cryptographic asset blockchain network as a full node of the token blockchain and the cryptographic asset blockchain,

The terminal 20 sends and receives information to and from the exchange server 40 and the gift distribution server 50, but is not a node of the token blockchain and the cryptographic asset blockchain.

The gift distribution server 50 sends and receives information to and from the server 10 and the terminal 20, but is not a node of the token blockchain or the cryptographic asset blockchain.

As an example, not as a limitation, a token (token data) is stored in a block of a token blockchain. In the present example embodiment, as an example, not as a limitation, one token records (stores) data (contract) indicating that a unique user can redeem a defined amount (value unit) of a cryptographic asset. The token may be referred to as a cryptographic asset exchange token.

As an example, not a limitation, in FIG. 4, data indicating that the token application user “A.A” (owner of the token wallet “A.A”) can redeem the cryptographic asset “5 LK” is recorded.

By redeeming the token (fulfilling the contract) according to this token (contract), the token application user “A.A” can, as an example, not as a limitation, obtain the cryptographic asset “5 LK” at the cryptographic asset exchange.

The redeemed token (a token for which the contract has been fulfilled) will be deactivated (e.g., cannot be redeemed again) in the token blockchain.

When the token is verified and agreed upon in the token blockchain, the token content is treated as data without tampering at each node of the token blockchain network (the token is approved in the token blockchain).

Some examples of specific implementations of token blockchain includes, as an example, not as a limitation, LINE Blockchain and Ethereum Blockchain (registered trademark).

A block in the cryptographic asset blockchain stores, as an example, not as a limitation, a transaction (transaction data).

In the present example embodiment, as an example, not as a limitation, one transaction records (stores) data indicating sending (transferring) a defined amount (value unit) of cryptographic assets from one user to another.

As an example, not a limitation, in FIG. 4, data indicating that the cryptographic asset “5 LK” is to be sent from the cryptographic asset application user “C.C” (cryptographic asset wallet of “C.C”) to the cryptographic asset application user “A.A” (cryptographic asset wallet of “A.A”) is recorded.

Granting a cryptographic asset to a specific user (cryptographic asset wallet of a specific user) through a new issuance (casting) of a cryptographic asset may be considered as a transaction.

After this transaction is sent to the cryptographic asset blockchain network and after incorporated into a block, when the transaction is accepted as valid (approved), the transfer (move) of cryptographic assets (value unit) between the receiver (payee) and sender (remitter) of the cryptographic asset is established.

As an example, not as a limitation, in the transaction in FIG. 4, when the transaction is approved, the unspent balance (UTXO: Unspent Transaction Output) of the cryptographic asset application user “C.C” (the cryptographic asset wallet of “C.C”) is consequently decreased (reduced) by “5 LK”, and the unspent balance of the cryptographic asset application user “A.A” (cryptographic asset wallet of “A.A”) is increased (gained) by “5 LK”.

Note that it may take some time for a transaction to be approved. Therefore, by performing an off-chain transaction, which is a transaction outside the cryptographic asset blockchain, increasing or decreasing the unused balance is performed in advance even if the transaction has not been approved. Then, a new transaction may be generated and processed (so-called “lightning”) with a content that summarizes the content of the off-chain traded transaction.

An example of a specific implementation of a cryptographic asset blockchain is Bitcoin (registered trademark) blockchain, as an example, not as a limitation.

### [Functional Configuration of Each Apparatus]

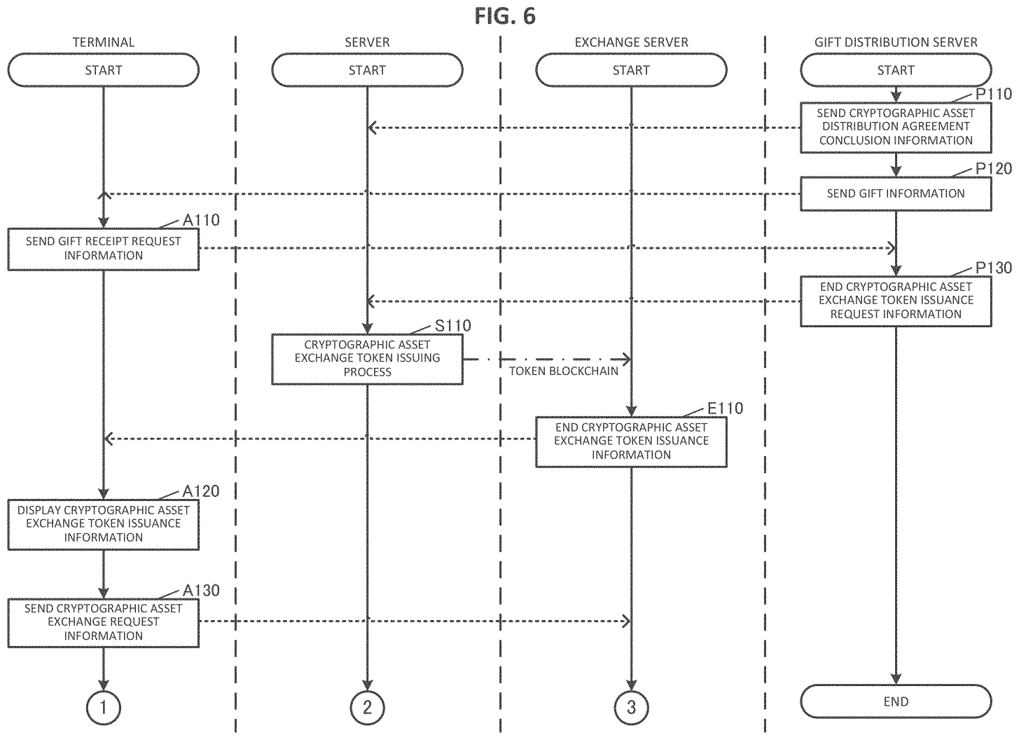

FIG. 5 illustrates an example of the functions realized by each apparatus in an example embodiment. The control unit 11 of the server 10 includes, as an example, not as a limitation, a token management processing unit 111 for performing a token management process according to a token management processing program stored in the storing unit 15, and a cryptographic asset management processing unit 112 for performing a cryptographic asset management process according to a cryptographic asset management processing program stored in storing unit 15.

The control unit 21 of the terminal 20 includes, as an example, not as a limitation, an application processing unit 211 for performing a token application process and a cryptographic asset application process according to a token application processing program and a cryptographic asset application processing program stored in the storing unit 28, as a functional part. The application processing unit 211 may be divided into a token application processing unit for performing the token application process and a cryptographic asset application processing unit for performing the cryptographic asset application process.

The storing unit 28 of the terminal 20 stores, as an example, not as a limitation, the token application processing program, the cryptographic asset application processing program, a token application ID, and a cryptographic asset application ID.

The token application ID may be information used to identify a token application account or the token application account itself.

This token application ID may be unique for each token application account, and as an example, not as a limitation, a unique value (singular value) may be set and stored for each account by the exchange server 40.

The token application ID may be information associated with the terminal 20 or the user of the terminal 20, and is an example of information regarding the terminal or the user of the terminal.

Identity verification (customer confirmation) (KYC: Know Your Customer) to the exchange server 40 (cryptographic asset exchange) may not be desired to obtain the token application ID. In the present example embodiment, it is assumed that the user of the terminal 20 has already obtained the token application ID in advance.

Here, the token application ID may also be a messaging application ID.

The cryptographic asset application ID is information used to identify a cryptographic asset application account or the cryptographic asset application account itself.

This cryptographic asset application ID may be unique for each cryptographic asset application account, and as an example, not as a limitation, a unique value (singular value) may be set and stored for each account by the exchange server 40.

The cryptographic asset application ID may be information associated with the terminal 20 or the user of the terminal 20, and may be an example of information regarding the terminal or the user of the terminal.

Identity verification (customer confirmation) (KYC: Know Your Customer) to the exchange server 40 (cryptographic asset exchange) may be desired to obtain the cryptographic asset application ID. Therefore, if the identify verification has not yet been performed, the cryptographic asset application ID may not be stored (takes a null value).

The control unit 41 of the exchange server 40 includes, as an example, not as a limitation, a token wallet processing unit 411, a cryptographic asset wallet processing unit 412, and a cryptographic asset KYC processing unit 413, as functional parts.

The token wallet processing unit 411 performs operations (references, additions, etc.) of tokens (transactions) stored (recorded) in the token blockchain in the token application management process performed according to the token application management processing program stored in the storing unit 45.

The cryptographic asset wallet processing unit 412 performs operations (references, additions, etc.) of transactions (tokens) stored in the cryptographic asset blockchain in the cryptographic asset application management process performed according to the cryptographic asset application management processing program stored in the storage unit 45.

The cryptographic asset KYC processing unit 413 performs a process related to the identity verification (KYC) desired to issue a wallet address (cryptographic asset wallet address) in the cryptographic asset blockchain to the user of the terminal 20 in the cryptographic asset application management process.

Here, in the token application management process, the cryptographic asset KYC processing unit 413 may perform a process related to verification (KYC) desired to associate the user information of the terminal 20 with the wallet address (token wallet address) in the token blockchain without discrepancy.

The storing unit 45 of the exchange server 40 stores, as an example, not as a limitation, the token application management processing program, the cryptographic asset application management processing program, user token data 481, and user cryptographic asset data 482.

The user token data 481 is information for associating the wallet address (token wallet address) of the token blockchain with the user information of the token application, and as an example, not as a limitation, the token wallet address, a token application ID, a user name, and other registration information are stored so as to associate with each other. In other words, the token wallet address is information associated with the owner of the token wallet (owner's information).

The user name is the name of the user of the terminal 20 who uses the token application, and, as an example, not as a limitation, a name that the user of the terminal 20 registers when the user uses the token application is stored.

The other registration information can include, as an example, not as a limitation, various types of information such as identification information to identify the terminal 20, telephone number of the terminal 20 (terminal telephone number), e-mail address (terminal e-mail address), a password used for various types of verification in the token application (login password, authentication password, etc.), and the like. The other registration information may also include identify verification information.

The identification information for identifying the terminal 20 can be, as an example, not a limitation, a terminal ID (as an example, not a limitation, IMEI (International Mobile Equipment Identity)). The identification information for identifying the user of the terminal 20 can be, as an example, not as a limitation, a token application ID. Here, “token user ID” or simply “user ID” may be used, instead of the token application ID.

If the application allows only one account to be registered per terminal 20, as an example, not as a limitation, it is possible to set as “identification information to identify terminal 20=identification information to identify the user of terminal 20=token application ID”.

As an example, not a limitation, it may be possible to assign multiple terminal IDs with respect to a single user ID.

It is also possible to apply a method of managing accounts by means of information such as terminal phone numbers or the like, instead of various IDs such as the token application IDs.

In this case, instead of having information on IDs such as token application IDs stored in the user token data 481, information such as terminal telephone numbers can be stored in the user token data 481.

The user cryptographic asset data 482 is information for associating the cryptographic asset blockchain wallet address (cryptographic asset wallet address) with the user information (e.g., cryptographic asset application ID, user name, and/or other registration information) of the cryptographic asset application. In other words, the cryptographic asset wallet address is information associated with the owner of the cryptographic asset wallet (owner information).

The user name is the name of the user of the terminal 20 through which the cryptographic asset application is used, and as an example, not as a limitation, the name of the user of the terminal 20 when he/she performs the identity verification (KYC) is stored.

The other registration information may include various types of information such as, as an example, not as a limitation, identification information to identify the terminal 20, telephone number of the terminal 20 (terminal telephone number), e-mail address (terminal e-mail address), passwords used for various verifications in the cryptographic asset application (login password, authentication password, etc.), identify verification information (address, date of birth, photo data, etc.) which is sent from the terminal 20 upon the identify verification (KYC), and the like.

In addition, the identification information for identifying the user of the terminal 20 can be, as an example, not as a limitation a cryptographic asset application ID. It may be “cryptographic asset user ID” instead of the cryptographic asset application ID.

In addition, instead of various IDs such as the cryptographic asset application ID, it is also possible to apply a method of managing accounts by information such as terminal phone numbers or the like, in the same manner as token application IDs.

The control unit 51 of the gift distribution server 50 includes, as an example, not as a limitation, as a functional part, a gift management processing unit 511 for performing gift distribution according to a gift management processing program stored in the storing unit 54.

The storing unit 55 stores, as an example, not as a limitation, the gift management processing program, gift account registration data, and gift management data.

The gift account registration data is registration data relating to an account of an application (in this example, a token application), and, as an example, not as a limitation, is stored in association with a user name, a token application ID, and other registration information. The user name, token application ID, and other registration information are, as an example, not as a limitation, common to those stored in the user token data 481.

As an example, not a limitation, the exchange server 40 sends the user name, token application ID, and other registration information in the user token data 481 to the gift distribution server 50 when a user registers for a new token application. Then, the gift distribution server 50 associates the received user name, token application ID, and other registration information with each other and stores them in the gift account registration data.

Gift management data stores, as an example, not as a limitation, gift information related to a cryptographic asset (virtual currency) gift distributed to the user of the terminal 20 in response to an answer to questionnaires, etc. on the token application.

The gift information is, as an example, not as a limitation, information regarding the distribution of a cryptographic asset (virtual currency) to the user of the terminal 20 at a price that is converted into an amount defined as a unit of legal tender.

As an example, not as a limitation, in the gift information, it is described that a contract that the cryptographic asset “LK” having a legal tender value of “5,000 yen”, is to be sent to the user of the terminal 20. In the gift information, the exchange rate between the cryptographic asset and legal tender is not desired to be considered, and the specific amount (unit) of virtual currency available to the user is not determined from the gift information alone.

Here, the exchange server 40 and the gift distribution server 50 may be configured as a single integrated server. In this case, the gift account registration data can be a subset of the user token data 481.

In addition, a messaging server (messaging application management server) with a function for providing a messaging service (chat service) may be configured as an integrated server with the exchange server 40 and the gift distribution server 50. In this case, the token application ID can be the messaging application ID, which is the account identification information of the messaging application. In some example embodiments, it is possible to map the token application ID to the messaging application ID on a one-to-one basis.

In addition, in the gift account registration data, a unique application ID (referred to as “gift application ID”) may be used instead of the token application ID.

In this case, as the user name and the other registration information, information entered by the user of the terminal 20 upon registering for use in the gift application is stored. Then, as an example, not as a limitation, the gift application ID and the token application ID are associated with each other according to an authorization action of the user of the terminal 20, and the gift application ID and the token application ID are stored in one of or both of the storing unit 45 of the exchange server 40 and the storing unit 55 of the gift distribution server 50, so as to associate with each other.

Similarly, the exchange server 40 and the messaging server may be configured as an integrated server, or the gift distribution server 50 and the messaging server may be configured as an integrated server.

The exchange server 40 and the payment application server may be configured as an integrated server, or the gift distribution server 50 and the payment application server may be configured as an integrated server.

In the present embodiment, the distribution provider first contracts with the issuing entity to grant a cryptographic asset to the user of the terminal 20 according to the gift information stored in the gift management data (conclusion of distribution contract). Then, the distribution provider requests, according to the gift information, the issuing entity to issue a token (as an example, not a limitation, “LK”) that can be redeemed for a desired (or alternatively, predetermined) amount of cryptographic assets (as an example, not as a limitation, “5000 yen”) by a user identifiable by the token application ID (as an example, not a limitation, “user A.A”).

The issuing entity then issues a new token in the token blockchain with the content requested by the distribution provider (token issuance).

At this time, the amount (monetary value) of the cryptographic asset that can be redeemed by the user is determined based on the exchange rate between cryptographic assets and legal tender.

As an example, not as a limitation, if the exchange rate is “1LK=500 yen”, a token that can be redeemed for cryptographic assets “LK” worth “5000 yen” is issued to “user A.A” for “10 LK (=5000/500)” of cryptographic assets.

The block containing the issued token is incorporated into the token blockchain (the token is approved in the blockchain). The token is then fixed as tamper-proof information in the token blockchain.

The cryptographic asset exchange reads the new block in the token blockchain and obtains the token contained in the new block. The cryptographic asset exchange then informs “User A.A” described in the token that the cryptographic asset “10 LK” can now be redeemed.

When the user A.A requests to redeem the cryptographic asset “10 LK” (cryptographic asset exchange request), the cryptographic asset exchange requests the user A.A to present the cryptographic asset application ID.

The user A.A has not obtained a cryptographic asset application ID. In other words, if the user A.A has not performed identity verification (KYC) at the cryptographic asset exchange, the user A.A sends information for identity verification (eKYC (electronic Know Your Customer) information as an example, not as a limitation) to the cryptographic asset exchange. Then, the cryptographic asset KYC processing unit 413 of the cryptographic asset exchange performs identity verification according to the eKYC information received from the user A.A.

Here, if the token application ID of the user A.A has already been done with identify verification (KYC completed) at the cryptographic asset exchange, the cryptographic asset KYC processing unit 413 may perform the identity verification for the cryptographic asset application ID according to the eKYC information used during the identity verification of the token application ID.

After the identity verification is performed, the cryptographic asset wallet processing unit 412 generates a cryptographic asset application ID for the user A.A, generates a cryptographic asset wallet address to be associated with that cryptographic asset application ID, and initializes the cryptographic asset wallet for the user A.A.

Then, the cryptographic asset KYC processing unit 413 of the cryptographic asset exchange stores the generated cryptographic asset application ID of the user A.A and the token application ID of the user A.A that has received the cryptographic asset exchange request so as to associate with each other.

Here, if the cryptographic asset exchange has performed identity verification (KYC) with respect to the cryptographic asset application ID and the identity verification (KYC) has not been performed with respect to the token application ID, the cryptographic asset KYC processing unit 413 may perform identity verification with respect to the token application ID according to the eKYC information that has been used for the identity verification of the cryptographic asset application ID.

Here, if, at the time of a request of the cryptographic asset exchange from the user, the identities of both the token application ID and the cryptographic asset application ID have been verified at the cryptographic asset exchange, before the token conversion request is made at the cryptographic asset exchange, the eKYC information used at the time of the identity verification of the token application ID and the eKYC information used at the time of the identity verification of the cryptographic asset application ID may be compared to confirm whether or not they are equal as the identity verification information.

If they are not equal as the identity verification information, the token wallet processing unit 411 may not perform the token conversion request.

In other words, by performing the identity verification with respect to the cryptographic asset application ID at the cryptographic asset exchange, it is possible to guarantee the identity regarding between the user (owner) of the cryptographic asset application ID and that of the token application ID.

Next, the token wallet processing unit 411 requests the issuing entity to issue a cryptographic asset in the quantity (value unit) described in the token (token conversion) to the cryptographic asset wallet identified by the cryptographic asset application ID (as an example, not as a limitation, the cryptographic asset wallet of the user A.A) (token conversion request).

When the token management processing unit 111 of the issuing entity receives, as an example, not as a limitation, a token conversion request from the cryptographic asset exchange via the token blockchain, the token management processing unit 111 requests the cryptographic asset management processing unit 112 to issue the amount (value unit) of cryptographic assets described in the token to the cryptographic asset wallet of the user A.A (token conversion).

Then, the cryptographic asset management processing unit 112 of the issuing entity sends a transaction of the cryptographic asset blockchain according to the request for issuance of the cryptographic asset from the token management processing unit 111, and issues the cryptographic asset (cryptographic asset issuance).

When a block containing the issued transaction is incorporated into the cryptographic asset blockchain (transaction is approved), the cryptographic asset exchange reads a new block in the cryptographic asset blockchain and obtains the transaction contained in the new block. The cryptographic asset exchange then notifies “user A.A” described in the transaction that the cryptographic asset “10 LK” has been granted.

When the granting of the cryptographic asset is complete, deactivating (cancelling) the token is instructed to the token blockchain based on the achievement of the contract (contract) (as an example, not as a limitation, the issuance of “10 LK” to “user A.A”) described in the token, at the cryptographic asset exchange (token cancellation). When the token is approved to be deactivated in the token blockchain, the token management processing unit 111 of the issuing entity cannot tokenize the deactivated token again.

### <Processes>

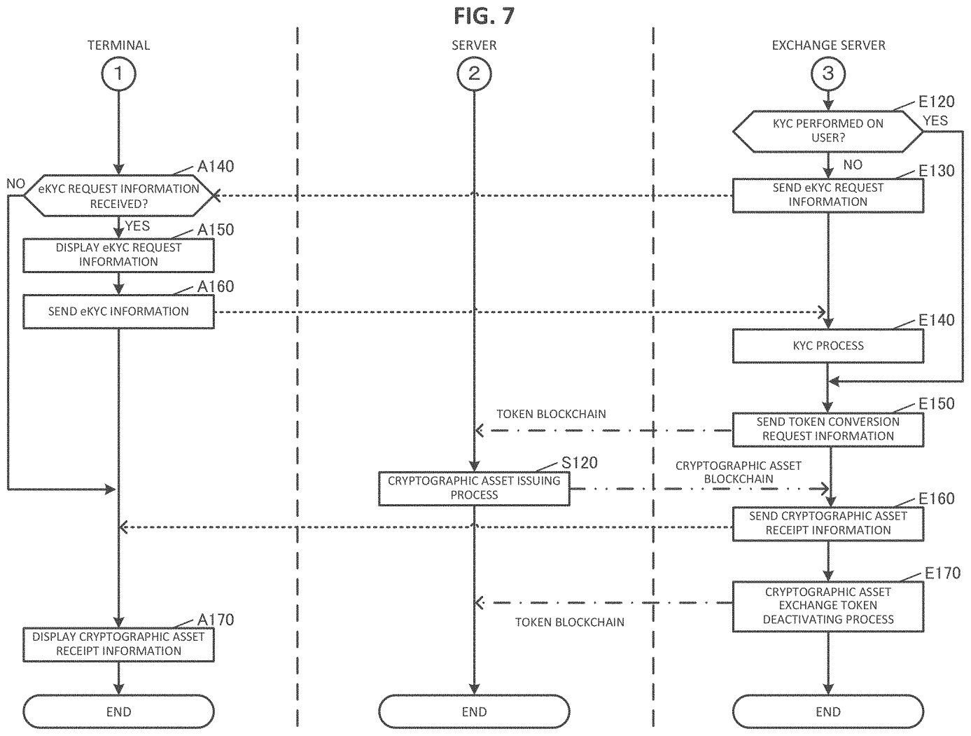

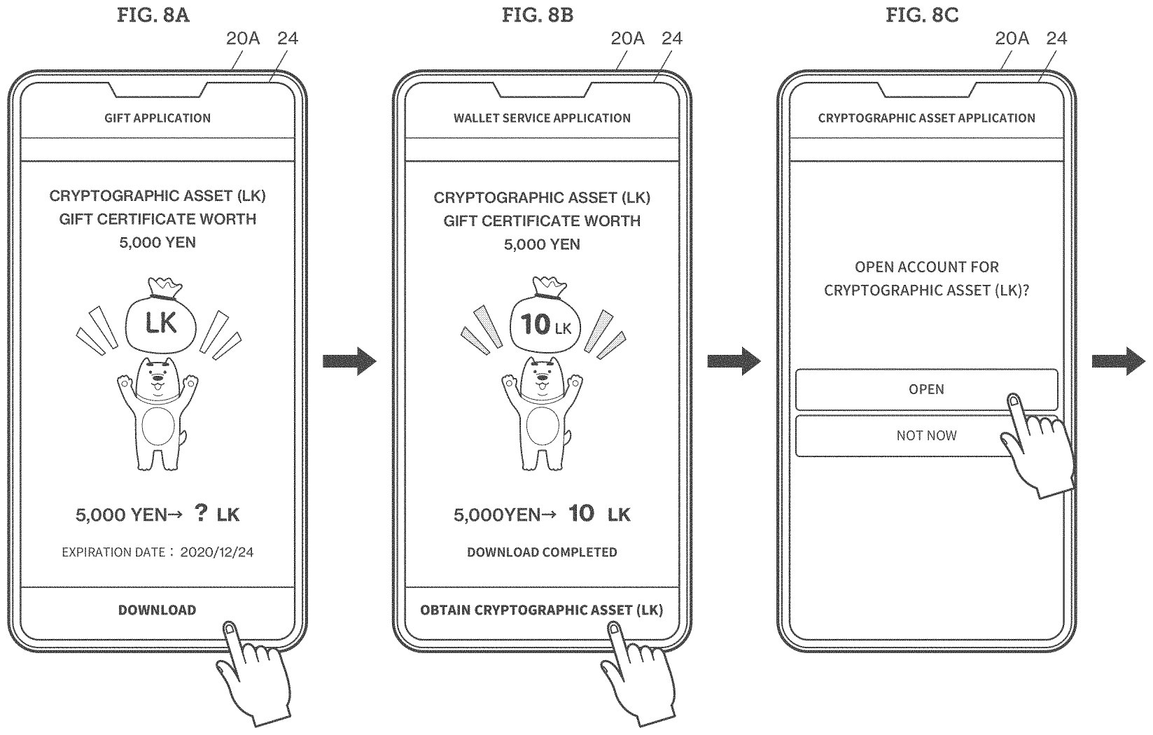

FIGS. 6 to 7 are flowcharts showing examples of the flows of processes performed by each apparatus in an example embodiment.

The figures show, from left to right, examples of the processes performed by the control unit 21 of the terminal 20A (the terminal 20 of the user A.A), the control unit 11 of the server 10, the control unit 41 of the exchange server 40, and the control unit 51 of the gift distribution server 50.

Here, these processes are only an example of processes for realizing the method of an example embodiment of the present disclosure and methods according to the present disclosure are not limited to these processes. Other steps may be added to these processes, or some steps may be omitted (deleted) from these processes.

This applies to the same for each flowchart (processes) described below.

First, the gift management processing unit 511 of the gift distribution server 50 sends cryptographic asset distribution agreement conclusion information for concluding an agreement on the distribution of a cryptographic asset to the server 10 by means of the communication I/F 44 (P110).

The cryptographic asset distribution agreement conclusion information is, as an example, not as a limitation, information for concluding an agreement to distribute a cryptographic asset with a value unit of X yen (X is an arbitrary amount) as legal currency (legal tender) value to a token application user.

When the cryptographic asset distribution agreement conclusion information is received from the gift distribution server 50 by means of the communication IF 14, the cryptographic asset management processing unit 112 of the server 10 receives the cryptographic asset distribution agreement conclusion information. At this time, the cryptographic asset management processing unit 112 of the server 10 may send information indicating that it has accepted the cryptographic asset distribution agreement conclusion information to the gift distribution server 50 by means of the communication UF 14.

Next, the gift management processing unit 511 of the gift distribution server 50 sends gift information based on the cryptographic asset distribution agreement conclusion information to the terminal 20A by means of the communication I/F 54 (P120).

The gift information is, as an example, not as a limitation, information indicating that a cryptographic asset with a legal currency (legal tender) value unit of X yen is to be distributed to the user A.A of the terminal 20A. The gift information is, an example, not as a limitation, one example of first information.

Here, this process is, an example, not as a limitation, one example of first process, where the cryptographic asset distribution agreement conclusion information is an example of first information.

Here, in the event that the gift management processing unit 511 of the gift distribution server 50 does not receive information indicating receipt of the cryptographic asset distribution agreement conclusion information from the server 10, the gift management processing unit 511 of the gift distribution server 50 may not send the gift information.

If the gift management processing unit 511 of the gift distribution server 50 receives information for sending the gift information from the terminal 20A (as an example, not as a limitation, such as a result of answers to a questionnaire), the gift management processing unit 511 may send the gift information to the terminal 20A.

Upon receiving the gift information from the gift distribution server 50 by means of the communication I/F 22, the application processing unit 211 of the terminal 20A displays the received gift information on the display unit 24.

As an example, not as a limitation, when the user selects to receive the cryptographic asset gift indicated by the gift information based on the user operation through the input/output unit 23 of the terminal 20A, the application processing unit 211 of the terminal 20A sends gift receipt request information for requesting a receipt of the cryptographic asset gift to the gift distribution server 50 by means of the communication I/F 22 (A110).

Here, when the gift information is received from the gift distribution server 50, the application processing unit 211 of the terminal 20A may automatically send the gift receipt request information.

Upon receiving the gift receipt request information from the terminal 20A by means of the communication I/F 54, the gift management processing unit 511 of the gift distribution server 50 sends cryptographic asset exchange token issuance request information for requesting issuance of a token (cryptographic asset exchange token) for the user of the terminal 20A to receive a cryptographic asset with a value unit of “X” yen (P130). The cryptographic asset exchange token issuance request information is, as an example, not as a limitation, one example of first information, and this process is, as an example, not as a limitation, one example of first process.

The gift management processing unit 511 of the gift distribution server 50 deactivate the gift information sent in the step of P120, and makes it not reusable (cannot be requested again).

Here, the application processing unit 211 of the terminal 20A may delete (deactivate) the received gift information when the gift receipt request information is sent to the gift distribution server 50.

Upon receiving the cryptographic asset exchange token issuance request information from the gift distribution server 50 by means of the communication I/F 14, the token management processing unit 111 of the server 10, based on the received cryptographic asset exchange token issuance request information, issues a cryptographic asset exchange token indicating (the contract content) that a cryptographic asset “Y” LK (“Y is the value unit of the virtual currency “LK” worth “X” yen converted according to the rate at the time of the cryptographic asset exchange token issuance process) is to be distributed (S110). As an example, not as a limitation, the cryptographic asset exchange token is an example of first information, and this process is an example of first process.

When the cryptographic asset exchange token is approved in the token blockchain, the cryptographic asset exchange token is fixed (stored) as tamper-proof information in the token blockchain. The token wallet processing unit 411 of the exchange server 40 reads the cryptographic asset exchange token and sends the cryptographic asset exchange token issuance information indicating that the cryptographic asset exchange token has been issued, to the terminal 20A by means of the communication I/F 14 (E110).

Accordingly, when the cryptographic asset exchange token is approved, the user to whom the cryptographic asset corresponding to the gift information is sent and the amount (value unit) of the cryptographic asset to be sent cannot be changed.

Upon receiving the cryptographic asset exchange token issuance information from the exchange server 40 by means of the communication I/F 22, the application processing unit 211 of the terminal 20 displays the received cryptographic asset exchange token issuance information on the display unit 24 (A120).

As an example, not as a limitation, if receiving a cryptographic asset according to the contents of the cryptographic asset exchange token is selected based on user operation through the input/output unit 23 of the terminal 20A, the application processing unit 211 of the terminal 20A sends the cryptographic asset exchange request information including an indication of receiving the cryptographic asset according to the content of the token and user A.A's cryptographic asset application ID (cryptographic asset wallet address owned by the user A.A) to the exchange server 40 by means of the communication I/F 22 (A130). If the cryptographic asset application ID of the user A.A does not exist, a null value is sent as the cryptographic asset application ID, as an example, not as a limitation.

The steps from A110 to A120 may be repeated at the terminal 20A to accumulate multiple cryptographic asset exchange token issuance information and multiple tokens may be redeemed together (cryptographic assets are received together).

Upon receiving cryptographic asset exchange request information from the terminal 20A via communication I/F 44, the cryptographic asset KYC processing unit 413 of the exchange server 40 determines whether the cryptographic asset application ID of the received cryptographic asset exchange request information is a null value (e.g., identity verification is not performed with respect to the cryptographic asset application) or not (E120).

If the identity verification has not been performed (E120: NO), the cryptographic asset KYC processing unit 413 of the exchange server 40 sends eKYC request information for requesting the submission of identity verification information to the terminal 20A by means of the communication I/F 44 (E130).

Even when a cryptographic asset application ID that is not a null value is sent, if the identity verification with respect to the token application ID of the terminal 20A has not been performed, the identity verification with respect to the token application ID is desired (E120: NO).

In this case, the cryptographic asset KYC processing unit 413 of the exchange server 40 may perform identity verification with respect to the token application ID based on the identity verification information stored in the user cryptographic asset data 482.

If the identity verification information stored in the user token data 481 and the identity verification information stored in the user cryptographic asset data 482 are not equal according to the token application ID of the terminal 20A and the cryptographic asset application ID, the identity verification may be performed again (E120: NO).

When eKYC request information is received from the exchange server 40 by means of the communication I/F 22 (A140: YES), the application processing unit 211 of the terminal 20A displays the received eKYC request information on the display unit 24 (A150).

As an example, not as a limitation, when identity verification information (name, address, date of birth, etc.) is input based on user operation through the input/output unit 23 of the terminal 20A, the application processing unit 211 of the terminal 20A uses the image capturing unit 27 to capture an identification document (as an example, not as a limitation, driver's license, health insurance card, and/or passport) and attach it to the identity verification information as image information to generate eKYC information. The application processing unit 211 of the terminal 20A then sends the eKYC information to the exchange server 40 by means of the communication I/F 22 (A160).

The identity verification information may be automatically recognized by the terminal 20A or the exchange server 40 based on the image information of the identification document.

The eKYC information may also include authentication information (as an example, not a limitation, user ID and password for authentication) for accessing a desired (or alternatively, predetermined) service in which the identity has already been verified.

In this case, the exchange server 40 can verify the identity of the user by sending authentication information to the desired (or alternatively, predetermined) service.

If the eKYC request information is not received from the exchange server 40 (A140: NO), the application processing unit 211 of the terminal 20A skips the steps A150 and A160.

Upon receiving the eKYC information from the terminal 20A via communication I/F 44, the cryptographic asset KYC processing unit 413 of the exchange server 40 receives the identity verification and generates a cryptographic asset application ID (cryptographic asset wallet address) of the user A.A based on the received eKYC information. Then, the cryptographic asset wallet processing unit 412 stores the generated cryptographic asset application ID and the identity verification information in the user cryptographic asset data 482 (E140).

If the identity verification in the token application has not been performed, when the cryptographic asset KYC processing unit 413 of the exchange server 40 receives the identity verification based on the received eKYC information as the identity verification with respect to the token application ID, the cryptographic asset KYC processing unit 413 stores the token application ID and the identity verification information so as to associate with each other.

When the cryptographic asset application ID is generated, the cryptographic asset KYC processing unit 413 of the exchange server 40 may send the cryptographic asset account opening information including the generated cryptographic asset application ID, to the terminal 20A by means of the communication I/F 44. The application processing unit 211 of the terminal 20A may then display the received cryptographic asset account opening information on the display unit 24.

If the identity verification is performed (E120: YES), the cryptographic asset KYC processing unit 413 of the exchange server 40 skips the steps E130 and E140.

Then, the token wallet processing unit 411 of the exchange server 40 sends, based on the cryptographic asset exchange request information, the token conversion request information that is to request the issuance of the cryptographic asset described in the cryptographic asset exchange token with respect to the cryptographic asset application ID (cryptographic asset wallet address) of the user A.A, to the smart contract of the server 10 in the token blockchain (E150). This process is an example, not a limitation, of second process.

At this time, the cryptographic asset application ID of the user A.A may be treated as an oracle to the token blockchain.

The token wallet processing unit 411 of the exchange server 40 may send the token conversion request information to the server 10 according to normal communication that does not involve the token blockchain. In this case, the token management processing unit 111 of the server 10 audits the content of the token subject to the token conversion request information.

When the smart contract of the server 10 is performed in the token management processing unit 111 based on the token conversion request information, the cryptographic asset management processing unit 112 issues cryptographic asset “Y” LK described in the cryptographic asset exchange token to the cryptographic asset wallet of the user A.A (S120). This process is an example, not a limitation, of second process.

The control unit 11 of the server 10 then terminates the process.

Instead of issuing a cryptographic asset, the cryptographic asset “Y” LK may be sent (transferred) as a transaction from a desired (or alternatively, predetermined) cryptographic asset wallet owned by a user of the server 10 to the cryptographic asset wallet of the user A.A.

When a cryptographic asset is issued (sent) to the cryptographic asset wallet of the user A.A, the cryptographic asset wallet processing unit 412 of the exchange server 40 sends cryptographic asset receipt information indicating that the cryptographic asset “Y” LK described in the token has been issued to the terminal 20A by means of the communication I/F 44 (E160).

Thereafter, the token wallet processing unit 411 of the exchange server 40 performs deactivation of the cryptographic asset exchange token that is the subject of the token conversion request information in the step of E150 to the token blockchain (E170). This process is an example, not a limitation, of second process.

Once the deactivation of the cryptographic asset exchange token is approved in the token blockchain, the cryptographic asset exchange token becomes non-reusable (deleted). The control unit 41 of the exchange server 40 then terminates the process.

When the cryptographic asset receipt information is received from the exchange server 40 by means of the communication I/F 22, the application processing unit 211 of the terminal 20A displays the received cryptographic asset receipt information on the display unit 24 (A170). Then, the application processing unit 211 of the terminal 20A terminates the process.

### <Display Screen>

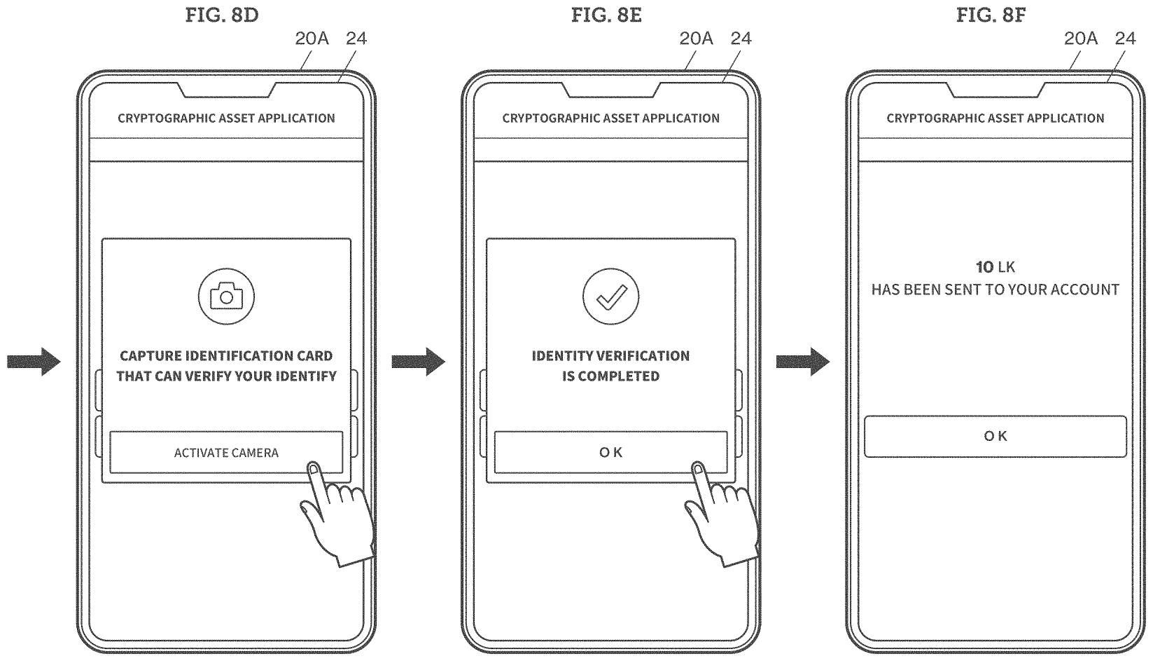

FIGS. 8A to 8F show screen diagrams showing examples of the transition of the display screens shown on display unit 24 when the terminal 20A receives the gift information. On the terminal 20A of the user A.A, which is the target of the gift information transmission, each of the information shown in FIG. 8A is displayed according to the gift application, as an example, not as a limitation. The screen displays the text “Cryptographic asset (LK) gift certificate worth 5,000 yen” and an image reminding the user that the cryptographic asset (LK) can be obtained.

In addition, the text “5000 yen->?LK” is displayed at the bottom of the screen, indicating that the LK equivalent to 5000 yen is not yet fixed, in other words, the LK that the user can obtain by the gift certificate is not fixed due to the fluctuation of the exchange rate between yen and LK. In addition, the text indicating that the gift certificate has an expiration date of “Dec. 24, 2020” is displayed. In addition, a button containing the word “Download” is placed at the bottom of the screen.

This indicates that the user can understand that by downloading this gift certificate before the expiration date (equivalent to sending the gift receipt request information, as an example, not a limitation), the user can obtain the cryptographic asset (LK).

When the download button is touched, authentication of the token application (as an example, not a limitation, input of the PIN set by the user of the terminal 20A to the token application) is requested, and after the token application is authenticated, the gift receipt request information is sent. The gift receipt request information may be sent after the token application is authenticated.

In other words, as an example rather than a limitation, a simpler authentication than the KYC process may be performed when issuing a cryptographic asset exchange token, and if the simpler authentication is successful, the cryptographic asset exchange token may be issued.

In addition, the user to whom the gift information is to be sent may, as an example, not as a limitation, send to a friend in the messaging application (as an example, not a limitation, a user B.B.) or others the right to receive the gift certificate cryptographic asset via the gift application or the messaging application, corresponding to full amount or for any amount.

When the user touches the button labeled “Download” on the screen (A), a transaction (token) including, as an example, not as a limitation, the token application ID (token wallet address of the user A.A), the date and time of issuance of the cryptographic asset exchange token, and expected issuance amount of the cryptographic asset (LK) is stored. As an example, not a limitation, the expected issuance amount of cryptographic assets (LK) is “10 LK”, which is equivalent to “5,000 yen” when the exchange rate at the timing when the cryptographic asset exchange token issuance process (S110) is performed is “1LK=500 yen”.

When the cryptographic asset exchange token is issued, each of the information shown in FIG. 8B is displayed on the terminal 20A by performing the wallet service application (token application), as an example, not as a limitation. The screen displays the text “Cryptographic asset (LK) gift certificate worth 5000 yen”, along with an image and text reminding that the user can obtain the cryptographic asset worth 10 LK (5000 yen->10 LK). The text “Download completed” is also displayed. In addition, a button containing the text “Receive cryptographic assets (LK)” is placed at the bottom of the screen.

Thereby, the user can understand that the user can obtain cryptographic asset equivalent to 10 LK.

On the screen FIG. 8B, when the user touches the button displaying “Obtain cryptographic asset (LK)” (corresponding to the transmission of cryptographic asset exchange request information), as an example, not as a limitation, the cryptographic asset application is performed, and if the KYC process with respect to the user has not been completed due to the execution of the cryptographic asset application, a message notifying that authentication with respect to the user is desired is displayed.

If the KYC process with respect to the user has been completed, the screen moves to the screen in FIG. 8F.

On the screen FIG. 8C, the message “Open account for cryptographic asset (LK)?” and below the message, a button containing the words “Open” and a button containing the words “Not now” are displayed. When the user touches the button that says “Open”, the information shown in FIG. 8D is displayed based on the fact that the KYC process with respect to the user has not yet been completed. On the other hand, if the user touches the button that says “Not now”, even if the KYC process with respect to the user has not yet been completed, the process to guide the user to the KYC process is not continued.

On the screen FIG. 8D, the message “Capture identification card that can verify your identity” is displayed along with the icon image of the camera. With these pieces of information, the user can recognize that the KYC process is desired in order to own a cryptographic asset. In addition, a button containing the text “Activate camera” is displayed below the message. When the user touches the button labeled “Activate camera”, the camera function of the terminal 20A is activated to enable the image capturing unit 27 capture a subject.

The user captures his/her identification (as an example, not as a limitation, a driver's license, passport or the like) with the image capturing unit 27 and the captured image is sent to the exchange server 40 based on the function of the cryptographic asset application. This allows the cryptographic asset exchange to confirm whether or not the identification is indeed that of the person in question (the user of the cryptographic application ID). If it is confirmed that the identification is of the person, the KYC process, including the association of the cryptographic application ID with the personal information on the captured ID, is performed at the exchange server 40.

Based on the completion of the KYC process, a transaction containing the cryptographic asset application ID (cryptographic asset wallet address of the user A.A), the date and time of the cryptographic asset (LK) transfer, and the amount of the cryptographic asset (LK) transfer is stored in the block of the cryptographic asset blockchain. As an example, not as a limitation, the remittance amount of the cryptographic asset (LK) is the expected issuance amount of the cryptographic asset (LK) contained in the transaction stored in the block of the token blockchain. In other words, the cryptographic asset application ID of the user is associated with the cryptographic asset based on the cryptographic asset exchange token. In addition, the terminal 20A of the user displays a message notifying that the identity verification has been completed.

On the screen FIG. 8E, the message “Identity verification is complete” is displayed. In addition, a button containing the text “OK” is displayed below the message.

When the user touches the button that says “OK”, the amount of the remitted cryptographic asset (LK) associated with the cryptographic asset application ID of the user is notified. On the screen FIG. 8F, the message “10 LK has been sent to your account” is displayed. This enables the user to understand that 10 LK worth of cryptographic assets have been sent to his/her newly opened account for cryptographic assets.

In addition, on the screen FIG. 8F, the button containing the text “OK” is displayed. When the user touches this button, as an example, not as a limitation, the number of the user account for cryptographic assets (as an example, not as a limitation, the cryptographic asset application ID, or the account number associated therewith) and the balance of the account (in units of value of cryptographic assets owned) may be displayed.

### Effects of First Example Embodiment

The above example embodiment of the present embodiment describes a configuration in which the server 10 (an example of information processing apparatus, not a limitation) performs a cryptographic asset exchange token issuance process (S110; as an example of first process, not as a limitation) for associating a cryptographic asset exchange token (as an example of first information, not as a limitation, a token related to the gift information) for a user of the terminal 20 to obtain LK (an example of cryptographic asset, not a limitation, and an example of cryptographic currency, not a limitation, and an example of a unit of cryptographic currency, not a limitation) with a token application ID (an example of identification information of user, not a limitation) of the user, and a cryptographic asset issuance (remittance) process (S120; as an example of second process, not as a limitation) for associating, based on a KYC process (an example of verification with respect to user, not a limitation) with respect to the user, the LK based on the cryptographic asset exchange token with a cryptographic asset application ID (as an example of identification information of user, not as a limitation) of the user.

As an example of the effect obtained by such a configuration, the user who has obtained first information can use the first information to obtain the cryptographic asset, thus it is possible to provide the user with an opportunity to own the cryptographic asset. In addition, when the terminal obtains first information, there is no need to associate the identification information of the user of the terminal beforehand (in advance). Therefore, the user can easily obtain the first information, and thereby user convenience is improved.

Thereby, it is possible to solve the problem that in a promotion where cryptocurrency (cryptographic assets and virtual currency) is distributed, the recipient of the cryptocurrency must, before receiving the distributed cryptocurrency, have an account to receive the cryptocurrency, and complete identification verification, account opening, and other procedures with the cryptographic asset exchange company that handles the cryptocurrency to distribute.

The present example embodiment also describes a configuration in which the gift distribution server 50 (an example of information processing apparatus, not a limitation) sends (an example of first process, not a limitation) gift information (as an example of first information, not as a limitation) for a user of the terminal 20 to obtain LK (an example of cryptographic asset, not a limitation, and an example of cryptographic currency, not a limitation, and an example of a unit of cryptographic currency, not a limitation), and performs a cryptographic asset issuance (remittance) process (S120; as an example of second process, not as a limitation) for associating, based on a KYC process (an example of verification with respect to user, not a limitation) with respect to the user, the LK based on the cryptographic asset exchange token with a cryptographic asset application ID (as an example of identification information of user, not as a limitation) of the user.

As an example of the effect obtained by such a configuration, the transmission of first information can be performed on an apparatus that is not associated with the possession (issuance) and management (exchange) of cryptographic assets, and thus the first information can be sent more easily by the user of the terminal.

In addition, since cryptocurrency distribution providers need to temporarily manage and hold cryptocurrency, from the perspective of avoiding the risk of cryptographic assets leaking, such entities are restricted to specific ones, such as cryptographic asset exchangers with a system in place for security measures, or ones that outsource management to cryptographic asset exchangers, however, this problem can be solved according to the present example embodiment.

In addition, the present example embodiment describes a configuration in which first information is associated with at least a unit of legal tender (not as a limitation, as an example of a unit of legal tender, a yen) before first process is performed, and after the first process is performed, the first information is associated with at least a unit of cryptographic asset (not a limitation, as an example of a unit of cryptographic currency, LK).

As an example of the effect obtained by such a configuration, before first process is performed, the user can understand a value that can be obtained by the first information based on the unit of legal tender, and after first process is performed, the user can understand a value that can be obtained by the first information based on the unit of the cryptographic asset.

The present example embodiment also describes a configuration in which first information is associated with at least a unit of the cryptographic asset based on an exchange rate between the legal tender and the cryptographic asset (1 LK=500 yen, as an example, not a limitation) when first process is performed.

As an example of the effect obtained by such a configuration, it is possible to provide a cryptographic asset to a user, using the first information, even when the value of the cryptographic asset relative to the legal tender fluctuates.

Thereby, when a cryptocurrency distribution provider grants the right to receive a cryptographic asset to a receiver (the provider is obligated to grant the right), it is possible to solve a problem of burden about accounting management, such as it is desired for the entity to bear a liability to manage the granting as debt or the like.

In addition, the present example embodiment describes a configuration of, when first process is performed, restricting first process for associating first information that is a subject of the first process, with identification information (as an example, token application ID, not as a limitation) of a user (second user) that is different from the user (first user) of the identification information (as an example, token application ID, not as a limitation) subject to first process.

As an example of the effect obtained by such a configuration, it is possible to restrict the acquisition of cryptographic assets based on first information by a user that is different from the user of which the first information has been obtained.

In addition, the present example embodiment also describes a configuration of, when second process is performed, restricting second process for associating the cryptographic asset based on first information that is the subject of first process, with the identification information (as an example, cryptographic asset application ID, not as a limitation) of the user that is the subject of second process.

As an example of the effect obtained by such a configuration, after a user has obtained a cryptographic asset based on first information, the user can be restricted from acquiring the cryptographic asset based on the first information again.

The present example embodiment also describes a configuration in which first information is associated with a token blockchain (an example of first blockchain, not a limitation) and a cryptographic asset is associated with a cryptographic asset blockchain (an example of second blockchain, not a limitation).

As an example of the effect obtained by such a configuration, a blockchain in which the first information is managed and a blockchain in which the cryptographic asset is managed are clarified.

The present example embodiment also describes a configuration in which, when first process is performed, first information (as an example, cryptographic asset exchange token, not a limitation) and the identification information of the user associated with first information (as an example, token application ID, not a limitation) are associated with the first blockchain, and when second process is performed, a cryptographic asset based on the first information and the identification information of the user (as an example, cryptographic asset application ID, not a limitation) are associated with the second blockchain.

As an example of the effect of such a configuration, a history related to the first process can be managed by the first blockchain and a history related to the second process can be managed by the second blockchain.

In addition, the present example embodiment describes a configuration in which a terminal displays on a display unit, information (as an example of first display information, not as a limitation, for example, a text of “Cryptographic asset gift certificate worth 5000 yen” and an image that can make a user understand that it is possible to obtain a cryptographic asset worth 10 LK), and displays on the display unit, information (as an example of second display information, not as a limitation, for example, a message of “10 LK has been sent to your account”) based on association of the LK based on a cryptographic asset exchange token with a cryptographic asset application ID (as an example of identification information of user, not as a limitation), based on a KYC process with respect to the user (as an example of verification with respect to user, not as a limitation).

As an example of the effect obtained by such a configuration, the user can be notified that the first information is associated with the identification information of the user, and the user can be notified that the cryptographic asset is associated with the identification information of the user.

In addition, the present example embodiment describes a configuration in which, when the first display information is displayed on the display, information notifying the user that verification with respect to the user is desired (as an example, the message “capture identification card that can verify your identity”, not a limitation) is displayed on the display unit.

As an example of the effect obtained by such a configuration, it is possible to notify the user that verification with respect to the user is desired in order for the cryptographic asset to be associated with the identification information of the user.

### First Variation Example (1) of First Example Embodiment

The example embodiment above describes an example in which a user obtains a cryptographic asset equivalent to a desired (or alternatively, predetermined) amount of legal tender (as an example, 5000 yen, not as a limitation) by means of a cryptographic asset exchange token (an example of first information, not a limitation). Not a limitation, a user may be able to obtain a cryptographic asset equivalent to a desired (or alternatively, predetermined) number of points (as an example, 5000 points, not a limitation) granted to the user based on the user's consumption by means of a cryptographic asset exchange token.

The point is, as an example, not as a limitation, a value that is associated with the identification information of the user when the user purchases a product or uses a service, and the like. The point may include a value granted to a user upon the fulfillment of a condition different from consumption activities, as an example, not as a limitation, viewing an advertisement, playing a game, and the like. The point may be a point that is associated with the user payment application ID when the user purchases a good or uses a service using the payment application, as an example, not as a limitation.

In this case, the payment application above is, not a limitation, may be an application that is performed in conjunction with a messaging application and its payment application ID is associated with the messaging application ID.

Here, the payment application (settlement application) is an application for making a payment/settlement in electronic money, such as an application for sending/receiving money in electronic money (remittance application), or an application that aggregates some or all of the functions of these applications.

The term “electronic money” means electronic money as distinguished from physical money, that is owned by a terminal or a user thereof that is controlled in the various applications described above.

Electronic money may be expressed as “electronic money” or “digital currency (digital money)”. In addition, legal tender or virtual currency may be used as “electronic currency (electric money)” or “digital currency (digital money)”.

In addition, “electronic currency (electric money)” or “digital currency (digital money)” may also include cryptocurrencies (cryptographic assets).

Virtual currency may also include physical money such as coupons.

It is also possible to have a chat service (messaging service) function as one function of the payment application, or to have a payment service function as one function of the chat application (messaging application).

The present variation example describes a configuration in which first information is associated with at least a unit of a point (as an example, not as a limitation) before first process is performed, and after the first process is performed, the first information is associated with at least a unit of a cryptographic asset (as an example of a unit of cryptocurrency, LK, not as a limitation).

As an example of the effect obtained by such a configuration, before first process is performed, the user can understand the value that can be obtained by the first information based on the unit of point, and after the first process is performed, the user can understand the value that can be obtained by the first information based on the unit of cryptographic asset.

The present variation example also describes a configuration in which, when first process is performed, first information is associated with at least the unit of the cryptographic asset based on an exchange rate between the point and the cryptographic asset (as an example, 1 LK=500 points, not as a limitation).

As an example of the effect obtained by such a configuration, first information can be used to provide a cryptographic asset to a user even when the value of the cryptographic assets in relation to the points fluctuates.

Here, the present variation example can be applied in a case where the exchange operator can exchange points for cryptographic assets (i.e., can provide cryptographic assets of a value equivalent to the amount of points used), but the present variation example can be applied even in a case where the exchange operator cannot exchange points for cryptographic assets. That is, if the cryptographic asset exchange token is associated with a desired (or alternatively, predetermined) number of points, the exchange operator may provide the cryptographic assets to the user based on the amount of legal tender equivalent to the desired (or alternatively, predetermined) number of points associated with the cryptographic asset exchange token.

In other words, the exchange between points and cryptographic assets may be permitted to the exchange operator.

### Second Variation Example (2) of First Example Embodiment

FIG. 8 shows examples of screens displayed on a terminal when a user uses a cryptographic asset exchange token, but the screens are not limited to such figures. As an example, not as a limitation, the screens may transition as follows on the terminal 20.

First, promotional information related to the payment application performed at the terminal 20A is displayed on the display unit 24 (as an example, not as a limitation, a talk room or timeline based on the messaging application in case that the payment application is performed in conjunction with the messaging application). This promotional information is, as an example, not as a limitation, information regarding a credit card that can be used for payment in that payment application. The promotional information is information that includes, as an example, not as a limitation, the message “If you create a credit card for the payment application, you will receive 5,000 yen as a gift”.

When the user touches the promotional information, a screen for entering information desired to issue a credit card is displayed on the display unit 24. When the user completes the credit card issuance procedure by entering desired information on that screen, the cryptographic asset exchange token associated with the promotional information is issued.

Based on the issuance of the cryptographic asset exchange token, the first display information based on the exchange rate at the time of issuance of the cryptographic asset exchange token is displayed on the display unit 24. The first display information is, as an example, not as a limitation, information including the message “You will receive 10 LK” based on the exchange rate of 1 LK=500 yen, and a button including the text “See Details”.

When the user touches the button displaying “See Details”, the wallet service application (as an example, not as a limitation, a token application with respect to a token application ID associated with the payment application ID or messaging application ID) is activated. The button containing the text “Get Cryptographic Assets (LK)” is displayed on the display unit 24.

When the user touches the button displaying “Obtain Cryptographic Assets (LK)”, the screen transitions to a screen (as an example, the screen shown in FIG. 8(C), not a limitation) that allows the user to confirm whether or not to open an account for cryptographic assets (LK).

As in the present variation example, the promotional information presented to the user prior to the issuance of the cryptographic asset exchange token may include information notifying the user that a desired (or alternatively, predetermined) amount of legal tender (5,000 yen) is to be given as a gift, but may not include information notifying the user that cryptographic asset (LK) a to be given.

In addition, as in the present variation example, when the promotional information is displayed in a talk room or timeline, multiple types of promotional information may be displayed.

In this case, as an example, not as a limitation, the first promotional information notifying that 5,000 yen is to be given to a user who has created a credit card that can be used for payment in the payment application and the second promotional information notifying that 1,000 yen is to be given to a user who has answered a questionnaire may be displayed, and the user may select one or both.

In this case, the first promotional information is, as an example, not as a limitation, information regarding the first value (not a limitation, but an amount of legal tender) that the user can obtain based on fulfillment of a first condition regarding the user, and the second promotional information is, as an example, not as a limitation, information regarding the second value (not a limitation, an amount of legal tender) that the user can obtain based on fulfillment of a second condition regarding the user.

In this example, the first value and the second value are different, but may be the same.

When a user selects the first promotion information and creates a credit card (not a limitation, when the first condition is satisfied), a cryptographic asset exchange token to obtain a cryptographic asset (LK) worth 5000 yen is associated with a token application ID of the user, and when if a user selects second information and responds to the questionnaire (not a limitation, when the second condition is satisfied), a cryptographic asset exchange token to obtain a cryptographic asset (LK) worth 1,000 yen is associated with the token application ID of the user.

### Third Variation Example (3) of First Example Embodiment

In the example embodiment above, it is assumed that the cryptographic asset exchange token issuance process and the cryptographic asset issuance process are performed at the server 10, but the configuration according to the present disclosure is not limited to such a case.

As an example, not as a limitation, an apparatus that performs the processes may be changed as follows.

(1) The exchange server 40 performs the cryptographic asset exchange token issuance process.

(2) The exchange server 40 performs the cryptographic asset issuance process.

(3) The exchange server 40 performs the cryptographic asset exchange token issuance process and the cryptographic asset issuance process.

In the case (1), as an example, not as a limitation, the gift management processing unit 511 of the gift distribution server 50 sends the cryptographic asset exchange token issuance request information to the exchange server 40 in step P130 of FIG. 6. The control unit 41 of the exchange server 40, upon receiving the cryptographic asset exchange token issuance request information, performs the cryptographic asset exchange token issuance process (as an example of first process, not as a limitation).

For this, the distribution agreement should be exchanged between the distribution provider, the issuing entity and the cryptographic asset exchange.

In the case (2), as an example, not a limitation, the token wallet processing unit 411 of the exchange server 40 sends the token conversion request information to the smart contract of the exchange server 40 in the token blockchain based on the cryptographic asset exchange request information.

Then, based on the token conversion request information, the cryptographic asset wallet processing unit 412 of the exchange server 40 sends the cryptographic asset “Y” LK described in the cryptographic asset exchange token from the desired (or alternatively, predetermined) cryptographic asset wallet owned by the exchange to the cryptographic asset wallet of the user A.A.

Therefore, even entities that are not issuing entities, as long as possessing sufficient cryptographic assets, can perform a process equivalent to the cryptographic asset issuance process (as an example of second process, not a limitation) by performing a remittance instead of issuing a cryptographic asset.

In the case (3), as an example, not as a limitation, the processes above should be combined.

In any of the cases (1) through (3), the processes of the server 10 and the exchange server 40 may be swapped exactly as they are. In this case, the user cryptographic asset data, or the user token data, or both, are stored in the storing unit 15 of the server 10.

In other words, since the first and second processes can be regarded as processes performed by the system comprising the server 10 and the exchange server 40 operating cooperatively, the operating entity (apparatus performing the process) of the first and second processes can be any.

### Fourth Variation Example (4) of First Example Embodiment

In the embodiment above, the exchange server 40 has the cryptographic asset wallet processing unit 412 and the token wallet processing unit 411 as functional parts, the configuration is not limited to such a case.

As an example, not as a limitation, two exchange servers (apparatuses), one having the cryptographic asset wallet processing unit as a functional part and storing user cryptographic asset data in a storing unit thereof, and the other having the token wallet processing unit as a functional part and storing user token data in a storing unit thereof, may be used to manage the processes of the exchange server 40.

Here, each of the cryptographic asset exchange management server and the token exchange management server may have a KYC processing unit (equivalent to the cryptographic asset KYC processing unit 413), or only one of them may have the KYC processing unit.

In this case, by making a communication between the cryptographic asset exchange management server and the token exchange management server as appropriate, it is possible to make the cryptographic asset wallet processing unit and the token wallet processing unit operate collaboratively to perform the processes of the exchange server 40.

More specifically, as an example, not as a limitation, the steps E110, E150 and E170 in FIG. 6 to FIG. 7 can be performed by the token exchange management server and the steps E120 to E140 and E160 in FIG. 6 to FIG. 7 can be performed by the cryptographic asset exchange management server.

### Fifth Variation Example (5) of First Example Embodiment

In the embodiment above, the rate conversion from legal tender equivalent to cryptographic asset value units described in the gift information is performed during the cryptographic asset exchange token issuance process (S110), but the configuration is not limited to such a case.

As an example, not as a limitation, the value conversion from legal tender to cryptographic assets (fixing the conversion rate) may be performed at the following timing at the server 10.

(A) At the time of concluding the cryptographic asset distribution agreement.

(B) At the time of receiving the cryptographic asset distribution agreement conclusion information.

(C) At the time of receiving the cryptographic asset exchange token issuance request information.

(D) During the cryptographic asset issuance process.

If the conversion rate is fixed at the time of cryptographic asset exchange token issuance, the conversion rate may be included as a token content. If the conversion rate is not fixed at the time of cryptographic asset exchange token issuance, the legal tender amount of redeemable cryptographic asset (as an example, “5,000 yen”, not as a limitation) is stored as a token content, and when the conversion rate is fixed, the conversion rate or the value unit of the converted cryptographic asset (as an example, not a limitation, “5 LK” when converted at “1 LK=1,000 yen”) may be added and stored at the time the conversion rate is determined.

The token management processing unit Ill of the server 10 may send the cryptographic asset conversion information which is to be sent after value conversion from legal tender to cryptographic assets at the time of conversion rate determination, or during the cryptographic asset issuance process. The terminal 20 may display the received cryptographic asset conversion information on the display unit 24 immediately, based on user operation through the input/output unit 23, or upon receipt of the cryptographic asset receipt information.

The conversion rate determination process may be performed by an apparatus other than the server 10. In this case, as an example, not as a limitation, the value conversion from legal tender to cryptographic assets (fixed conversion rate) may be performed at the following timing in FIG. 6 to FIG. 7.

(E) At the time of sending the cryptographic asset distribution agreement conclusion information (P110).

(F) At the time of sending the gift information (P120).

(G) At the time of sending the gift receipt request information (A110).

(H) At the time of sending the cryptographic asset exchange token issuance request information (P130)

(I) At the time of sending the cryptographic asset exchange token issuance information (E110).

(J) At the time of sending the cryptographic asset exchange request information (A130).

(K) At the time of sending the eKYC request information (E130).

(L) At the time of sending the eKYC information (A160).

(M) At the time of sending the token conversion request information (E150).

### Second Example Embodiment

The example embodiments above use two blockchains, a token blockchain and a cryptographic asset blockchain, the number or the kind of blockchain(s) is not limited to such a case.

The second example embodiment is an example in which a token (cryptographic asset exchange token) and a cryptographic asset transaction are stored (kept) in a single blockchain.

The contents described in the second example embodiment can be applied to any of the other example embodiments or other variation examples.

The same components as in the previous example embodiment and variation examples are indicated with the same symbols and the description thereof will be omitted.

In the following, a blockchain in which a token and a transaction of cryptographic assets are stored (kept) is referred to as “common blockchain”. In other words, the server 10 and the exchange server 40 function as a node (as an example, a full node, not a limitation) of the common blockchain.

However, in a cryptographic asset exchange, a distinction shall be made between a token wallet which handles tokens, and a cryptographic asset wallet which handles cryptographic assets. In other words, in the exchange server 40, similar to the first example embodiment, there is a distinction between the cryptographic asset wallet and the token wallet as wallets in the common blockchain.

In the issuing entity, there is no need to distinguish between the token wallet that handles tokens and the cryptographic asset wallet that handles cryptographic assets. Therefore, the server 10 does not need to distinguish between the token management processing unit 111 and the cryptographic asset management processing unit 112.

Hereafter, the wallet at the issuing entity that handles tokens and cryptographic asset transactions will be referred to as “common wallet” as an example, not as a limitation.

In addition, in the server 10, the processing unit for handling the common wallet is referred to as “common blockchain management processing unit” as an example, not as a limitation. The common blockchain management processing unit corresponds to a processing unit that has the functions of both the token management processing unit 111 and the cryptographic asset management processing unit 112.

### <Processes>

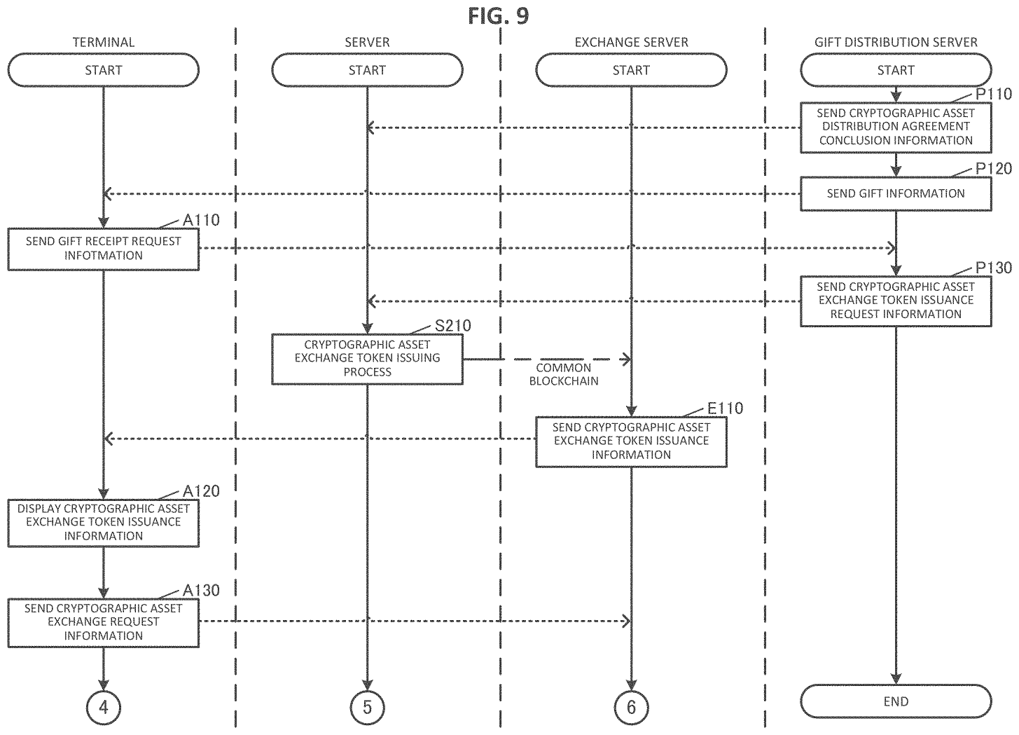

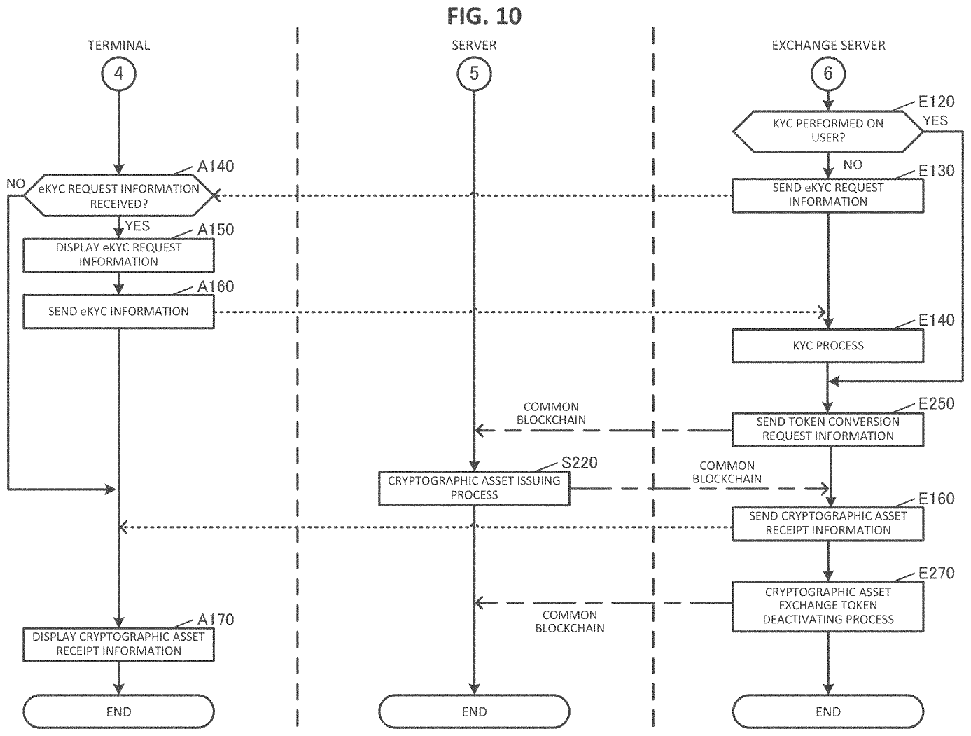

FIGS. 9 and 10 are flowcharts showing an example of the flow of processes performed by each apparatus in the second example embodiment.

These figures, from left to right, show examples of the processes performed by the control unit 21 of the terminal 20A (the terminal 20 of user A.A), the control unit 11 of the server 10, the control unit 41 of the exchange server 40, and the control unit 51 of the gift distribution server 50.

The step of P130 is performed.

Then, upon receiving the cryptographic asset exchange token issuance request information from the gift distribution server 50 by means of the communication I/F 14, the common blockchain management processing unit of the server 10 issues to the common wallet, based on the received cryptographic asset exchange token issuance request information, a cryptographic asset exchange token (which is the contractual content) indicating a cryptographic asset “Y” LK (“Y” is the value unit of the virtual currency “LK” worth “X” yen converted at the rate at the time of the cryptographic asset exchange token issuance process) is to be distributed (S210). The present process is an example of first process, not as a limitation.

When the cryptographic asset exchange token is approved in the common blockchain, the cryptographic asset exchange token is fixed (stored) as tamper-proof information in the common blockchain. The token wallet processing unit 411 of the exchange server 40 reads the cryptographic asset exchange token stored in the common blockchain and sends to the terminal 20A by means of the communication I/F 14, the cryptographic asset exchange token issuance information indicating that the cryptographic asset exchange token has been issued (E110).

After the step of E140, the token wallet processing unit 411 of the exchange server 40, based on the cryptographic asset exchange request information, sends to the smart contract of the server 10 in the common blockchain, the token conversion request information that is to request issuance of a cryptographic asset described in the cryptographic asset exchange token to the cryptographic asset application ID (cryptographic asset wallet address) of the user A.A (E250). This process is an example of second process, not a limitation.

When the smart contract of the server 10 is performed in the common blockchain management processing unit based on the token conversion request information, the common blockchain management processing unit issues the cryptographic asset “Y” LK described in the cryptographic asset exchange token to the cryptographic asset wallet of the user A.A (S220). This process is an example of second process, not a limitation.

Instead of issuing a cryptographic asset, the cryptographic asset “Y” LK may be sent (transferred) as a transaction from the desired (or alternatively, predetermined) cryptographic asset wallet owned by the user of the server 10 to the cryptographic asset wallet of the user A.A.

When a cryptographic asset is issued (remitted) to the cryptographic asset wallet of the user A.A, the cryptographic asset wallet processing unit 412 of the exchange server 40 sends cryptographic asset receipt information indicating that the cryptographic asset “Y” LK described in the token has been issued, to the terminal 20A via communication I/F 44 (E160).

The token wallet processing unit 411 of the exchange server 40 then deactivates the cryptographic asset exchange token that is the subject of the token conversion request information to the common blockchain (E270). This process is an example of second process, not a limitation. When the deactivation of the cryptographic asset exchange token is approved in the common blockchain, the cryptographic asset exchange token becomes no longer reusable (deleted).

### Effects of Second Example Embodiment

The second example embodiment describes a configuration in which first information is associated with a blockchain (as an example, not as a limitation, a common blockchain) and a cryptographic asset is associated with the blockchain.

As an example of the effect obtained by such a configuration, due to the fact that the blockchain in which the first information is managed and the blockchain in which the cryptographic asset is managed are common (e.g., are represented by a common block chain), it is possible to clarify the blockchain to which information based on processing by the information processing apparatus is associated.

In addition, the second example embodiment describes a configuration in which, when first process is performed, first information (as an example, not as a limitation, cryptographic asset exchange token) and the identification information of the user associated with the first information (as an example, not as a limitation, token application ID) are associated with a blockchain (as an example, not as a limitation, a common blockchain), and when second process is performed, the cryptographic asset based on the first information and the identification information of the user (as an example, not a limitation, cryptographic asset application ID) are associated with the blockchain.

As an example of the effect obtained by such a configuration, a history related to the first process and a history related to the second process can be managed by the common blockchain.

### First Variation Example (1) of the Second Example Embodiment

In the second example embodiment above, a distinction is made between a token wallet that handles tokens and a cryptographic asset wallet that handles cryptographic assets in a cryptographic asset exchange, but the configuration is not limited to such a case. As an example, not as a limitation, in the cryptographic asset exchange, a wallet that handles both tokens and cryptographic asset transactions (hereinafter referred to as “exchange common wallet”) may also be used.

In this case, in the exchange common wallet, the use of the exchange common wallet for tokens does not need identification of the user of the terminal 20 with respect to the cryptographic asset exchange, but the use of the exchange common wallet for transactions of cryptographic assets needs identification of the user of the terminal 20 with respect to the cryptographic asset exchange, and thereby it is possible to realize the same way as the processing above.

### Third Example Embodiment

The second example embodiment above describes an example in which the terminal 20 and the gift distribution Server 50 are not a node of the blockchain, the configuration is not limited to such a case.

The third example embodiment is an embodiment in which the terminal 20 and the gift distribution server 50 are nodes of the blockchain.

The contents described in the third example embodiment can be applied to any of the other example embodiments or other variation examples.

The same components as in the previous example embodiments will be indicated with the same symbols and the description thereof will be omitted.

In the third example embodiment, the terminal 20 is connected as a lightweight node of the token blockchain and the cryptographic asset blockchain, to the token blockchain network and the cryptographic asset blockchain network, as an example, not as a limitation.

The terminal 20 may be connected as a full node in the token blockchain and/or cryptographic asset blockchain.

In addition, the gift distribution server 50 is connected to the token blockchain network as a lightweight node in the token blockchain, as an example, not as a limitation.

The gift distribution server 50 may be connected as a full node in the token blockchain.

Further, in addition to the token blockchain, the gift distribution server 50 may be connected to the cryptographic asset blockchain network as a node of the cryptographic asset blockchain (as an example, not as a limitation, as a full node or a lightweight node).

In the storing unit 28 of the terminal 20, as an example, not as a limitation, information (hereinafter referred to as “terminal token wallet information”) regarding a token wallet (hereinafter referred to as “terminal token wallet”) generated in the terminal 20 and information (hereinafter referred to as “terminal cryptographic asset wallet information”) regarding a cryptographic asset wallet (hereinafter referred to as “terminal cryptographic asset wallet”) generated in the terminal 20 are stored in addition to information regarding the cryptographic asset wallet (hereinafter referred to as “terminal cryptographic asset wallet information”). The information is stored in addition.

Identity verification to the exchange server 40 (cryptographic asset exchange) is not needed for the generation of the terminal token wallet and the terminal cryptographic asset wallet.

Prior to the process, the application processing unit 211 of the terminal 20 may have generated the terminal token wallet and the terminal cryptographic asset wallet.

In the third example embodiment, the token application is an application for referencing and operating the terminal token wallet, and the cryptographic asset application is an application for referencing and operating the terminal cryptographic asset wallet.

In other words, the token application ID is, as an example, not as a limitation, the terminal token wallet address itself, or an identifier that is uniquely associated with the terminal token wallet address.

The cryptographic asset application ID is, as an example, not as a limitation, the terminal cryptographic asset wallet address itself, or an identifier that is uniquely associated with the terminal cryptographic asset wallet address.

The storing unit 55 of the gift distribution server 50 stores in addition information (hereinafter referred to as “gift token wallet information”) regarding the token wallet (hereinafter referred to as “gift token wallet”) generated by the gift distribution server 50, as an example, not as a limitation.

After the gift token wallet is generated, prior to the process, the gift management processing unit 511 of the gift distribution server 50 performs identity verification (business verification) with respect to the server 10 (issuing entity) as to the gift token wallet. This allows the server 10 to identify the distribution provider based on the gift token wallet address.

### <Processes>

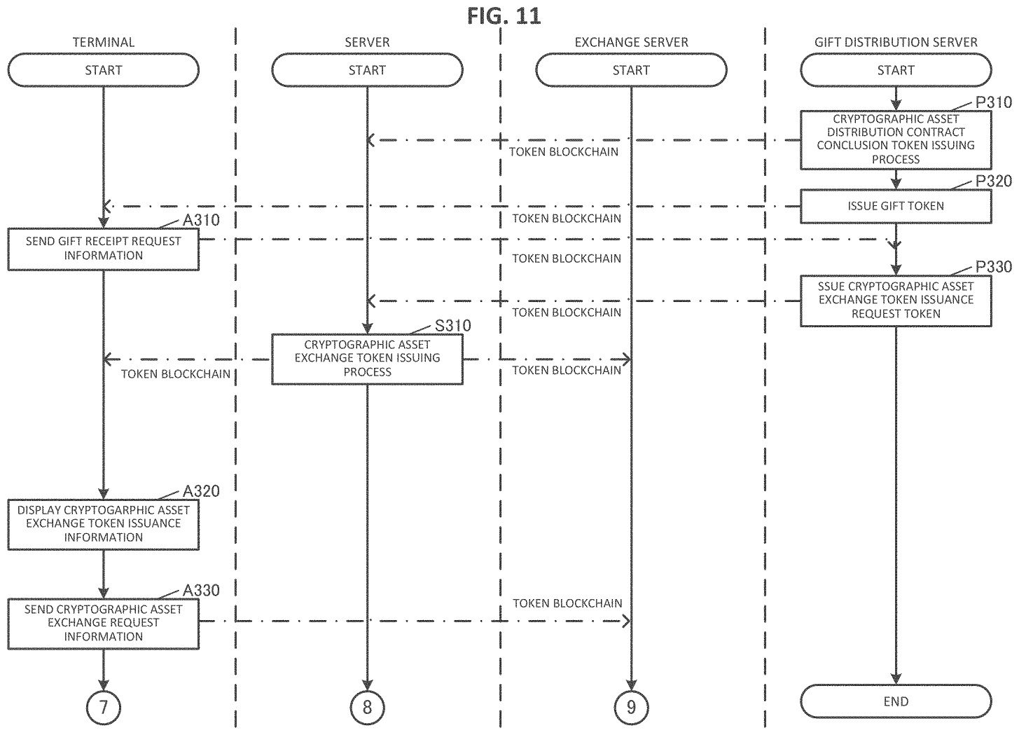

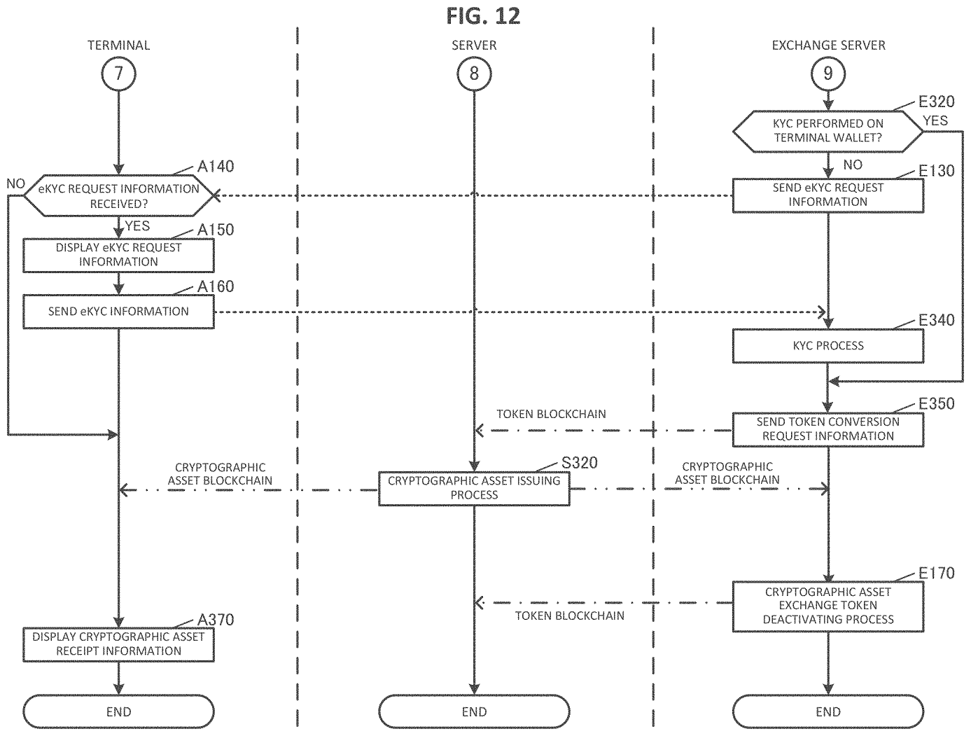

FIGS. 11 and 12 are flowcharts showing an example of the flow of processes performed by each apparatus in the present embodiment.

These figures, from left to right, show an example of the processes performed by the control unit 21 of the terminal 20A (terminal 20 of user A.A), the control unit 11 of the server 10, the control unit 41 of the exchange server 40, and the control unit 51 of the gift distribution server 50.

First, the gift management processing unit 511 of the gift distribution server 50 sends to the token blockchain, a token (hereinafter referred to as “cryptographic asset distribution contract conclusion token”) that describes an arrangement for concluding a contract for the distribution of cryptographic assets (P310).

The cryptographic asset distribution agreement conclusion token is, as an example, not as a limitation, a token that contains an agreement indicating the distribution of a cryptographic asset with a value unit of X yen (where X is an arbitrary amount) as legal tender (legal tender) value to a token application user, in response to a request from the gift token wallet address.

In the token blockchain, when the cryptographic asset distribution contract conclusion token is approved, the token management processing unit 111 of the server 10 receives the contract contents stored in the cryptographic asset distribution contract conclusion token. At this time, the cryptographic asset management processing unit 112 of the server 10 may send to the gift distribution server 50 via communication I/F 14, information indicating the receipt of the contents of the cryptographic asset distribution agreement conclusion token.

Next, the gift management processing unit 511 of the gift distribution server 50 issues to the token blockchain, a gift token based on the contents of the cryptographic asset distribution agreement conclusion token (P320).

The gift token is a token with the content indicating the distribution of a cryptographic asset with a value unit of X yen as legal currency (legal tender) value to the owner of the token wallet of the terminal 20A, as an example, not as a limitation. The gift token is an example of first information, not a limitation.

The present process is an example of first process, not a limitation, when the cryptographic asset distribution agreement conclusion token is an example of first information.

Here, if information indicating the receipt from the server 10 of the contents of the cryptographic asset distribution agreement conclusion token is not received, the gift management processing unit 511 of the gift distribution server 50 may not issue the gift token.

In addition, if the gift management processing unit 511 of the gift distribution server 50 receives information for issuing a gift token from the terminal 20A (as an example, not as a limitation, e.g., results of responses to a questionnaire), the gift token may be issued.

When the gift token is approved in the token blockchain, the application processing unit 211 of the terminal 20A displays the contents of the activated gift token on the display unit 24.

As an example, not as a limitation, if the user chooses to receive a gift of the virtual currency indicated by the gift token based on the user operation through the input/output unit 23 of the terminal 20A, the application processing unit 211 of the terminal 20A sends the gift receipt request information to the smart contract of the gift distribution server 50 in the token blockchain (A310).

Here, when the gift token is approved, the application processing unit 211 of the terminal 20A may automatically send the gift receipt request information to the smart contract of the gift distribution server 50.

When the smart contract based on the gift receipt request information is performed at the gift distribution server 50, the gift management processing unit 511 of the gift distribution server 50 issues to the token blockchain, a cryptographic asset exchange token issuance request token in which a content indicating a request to issue a token (cryptographic asset exchange token) for the owner of the token wallet of the terminal 20A to receive a cryptographic asset with a value unit of “X” yen (P330). The cryptographic asset exchange token issuance request token is an example of first information, not a limitation, and the present process is an example of first process, not as a limitation.

Then the gift management processing unit 511 of the gift distribution server 50 deactivates the gift token for which the smart contract has been processed and makes it not reusable (not reclaimable).

When the cryptographic asset exchange token issuance request token is approved in the token blockchain, the token management processing unit 111 of the server 10 issues to the owner of the token wallet of the terminal 20A, based on the contents of the cryptographic asset exchange token issuance request token, a cryptographic asset exchange token indicating (constituting a contract content) the distribution of a cryptographic asset with a value of “Y” LK worth X yen at the time, (“Y” being the value unit of the virtual currency “LK” worth “X” yen when converted at the rate at the time of the cryptographic asset exchange token issuance process). The cryptographic asset exchange token is as an example of first information, not as a limitation, and the present process is an example of first process, not a limitation.

When the cryptographic asset exchange token is approved in the token blockchain, the cryptographic asset exchange token is fixed (stored) as tamper-proof information in the token blockchain. The application processing unit 211 of the terminal 20A reads the cryptographic asset exchange token and displays cryptographic asset exchange token issuance information on the display unit 24, indicating that the cryptographic asset exchange token has been issued (A320).

As an example, not as a limitation, if it is selected based on user operation through the input/output portion 23 of the terminal 20A to receive a cryptographic asset in accordance with the contents of the cryptographic asset exchange token, the application processing unit 211 of the terminal 20A sends the cryptographic asset exchange request information including an indication that the cryptographic asset is to be received in accordance with the contents of the token and the cryptographic asset application ID of the user A.A (terminal cryptographic asset wallet address owned by the user A.A), to the smart contract of the exchange server 40 in the token blockchain (A330). If the cryptographic asset application ID of the user A.A does not exist, a null value is sent as the cryptographic asset application ID, as an example, not a limitation.

The steps from A310 to A320 may be repeated at the terminal 20A to accumulate multiple cryptographic asset exchange token issuance information and multiple tokens may be redeemed together (cryptographic assets may be received together).

When the smart contract is performed based on the cryptographic asset exchange request information on the exchange server 40, the cryptographic asset KYC processing unit 413 of the exchange server 40 judges whether the identify verification with respect to the terminal cryptographic asset wallet of the received cryptographic asset exchange request information has been performed at the cryptographic asset exchange (i.e. the cryptographic asset exchange has performed the identify verification in the cryptographic asset application) (E320).

If the identity verification has not been performed (E320: NO), the cryptographic asset KYC processing unit 413 of the exchange server 40 sends eKYC request information for requesting the submission of identity verification information to the terminal 20A by means of the communication I/F 44 (E130).

Here, if the identity verification with respect to the terminal token wallet of the terminal 20A has not been performed at the cryptographic asset exchange, the identity verification with respect to the terminal token wallet (token application ID) of the terminal 20A is desired (E320: NO).

In this case, the cryptographic asset KYC processing unit 413 of the exchange server 40 may perform identity verification with respect to the terminal token wallet based on the identity verification information stored in the user cryptographic asset data 482.

Here, the identity verification may be performed if the identity verification information stored in the user token data 481 and the identity verification information stored in the user cryptographic asset data 482 are different, with respect to the token application ID of the terminal 20A and the cryptographic asset application ID (E320: NO)

Upon receiving the eKYC information from the terminal 20A by means of the communication I/F 44, the cryptographic asset KYC processing unit 413 of the exchange server 40 receives the identity verification based on the received eKYC information. Then, the cryptographic asset wallet processing unit 412 stores the cryptographic asset application ID (terminal cryptographic asset wallet address) of the user A.A and the identity verification information in the user cryptographic asset data 482 (E340).

Here, if the identify verification at the token application has not been performed, the cryptographic asset KYC processing unit 413 of the exchange server 40 may store the token application ID (terminal token wallet address) and the identity confirmation information so as to associate with each other, in response to receiving the identify verification based on the received eKYC information as the identity verification with respect to the token application ID (terminal token wallet).

If the identity verification has been performed (E320: YES), the cryptographic asset KYC processing unit 413 of the exchange server 40 skips the steps E130 and E340.

Then, the token wallet processing unit 411 s of the exchange server 40 sends token conversion request information that is to request the terminal cryptographic asset wallet of the terminal 20A (terminal cryptographic asset wallet address of the terminal 20A) to issue to the smart contract of the server 10 in the token blockchain (E350). This process is an example of second process, not a limitation. At the time, the terminal cryptographic asset wallet address of the terminal 20A may be treated as an oracle to the token blockchain.

When the smart contract of the server 10 is performed in the token management processing unit 111 based on the token conversion request information, the cryptographic asset management processing unit 112 issues a cryptographic asset “Y” LK described in the cryptographic asset exchange token to the terminal cryptographic asset wallet of the terminal 20A (S320). This process is an example of second process, not a limitation.

Instead of issuing a cryptographic asset, the cryptographic asset “Y” LK may be sent (transferred) as a transaction from the desired (or alternatively, predetermined) cryptographic asset wallet owned by the user of the server 10 to the terminal cryptographic asset wallet of the terminal 20A.

When a cryptographic asset is issued (transferred) to the terminal cryptographic asset wallet of the terminal 20A, the application processing unit 211 of the terminal 20A displays the cryptographic asset receipt information on the display unit 24 (A370). Then, the application processing unit 211 of the terminal 20A terminates the process.

### First Variation Example (1) of Third Example Embodiment

In the third example embodiment above, the terminal 20 is a node of the token blockchain and the cryptographic asset blockchain, and the gift distribution server 50 is a node of the token blockchain, but the configuration is not limited to such a case.

As an example, not a limitation, the terminal 20 and the gift distribution server 50 may be nodes of a common blockchain.

The process in this case can be realized by combining the processes of the second and third example embodiments, as an example, not a limitation.

### Second Variation Example (2) of Third Example Embodiment

In the third embodiment above, the terminal 20 is a node of the token blockchain and the cryptographic asset blockchain, and the gift distribution server 50 is a node of the token blockchain, but the configuration is not limited to such a case.

As an example, not a limitation, the terminal 20 may be a node of the token blockchain and the cryptographic asset blockchain, and the gift distribution server 50 may not be a node of the token blockchain.

As an example, not as a limitation, the process in this case can be realized by replacing a part of the process in the third embodiment with the process in the first example embodiment.

The terminal 20 is a node of the token blockchain, but may not be a node of the cryptographic asset blockchain. In addition, the terminal 20 may also be a node of the cryptographic asset blockchain, but may not be a node of the token blockchain.

### Third Variation Example (3) of Third Example Embodiment

The third example embodiment above assumes that the terminal 20 is a node of the token blockchain and cryptographic asset blockchain and the gift distribution server 50 is a node of the token blockchain, but the configuration is not limited to such a case.

As an example, not as a limitation, the terminal 20 may not be a node of the token blockchain and the cryptographic asset blockchain, and the gift distribution server 50 may be a node of the token blockchain.

As an example, not as a limitation, the process in this case can be realized by replacing a part of the process in the third example embodiment with the process in the first embodiment.

Here, the terminal 20 may be a node of the token blockchain, but may not be a node of the cryptographic asset blockchain. In addition, the terminal 20 may also be a node of the cryptographic asset blockchain, but may not be a node of the token blockchain.

### Fourth Example Embodiment

In the example embodiment above, contract information (cryptographic asset exchange token) that allows a specific user to receive a desired (or alternatively, predetermined) amount of cryptographic assets based on gift information is stored in the token blockchain in a tamper-proof manner, but the configuration is not limited to such a case.

The fourth example embodiment is an example embodiment in which the contract information (cryptographic asset exchange token) is stored and kept in a physical medium.

The contents described in the fourth example embodiment can be applied to any of the other embodiments or the other variation examples.

In addition, the same components as those already described will be marked with the same symbols and the description thereof will be omitted.

As an example, not as a limitation, the server 10 causes contents of the cryptographic asset exchange token to be recorded on a tamper-proof physical medium (as an example, not as a limitation, an IC card) in the cryptographic asset exchange token issuance process. This IC card is hereinafter referred to as “token IC card”. As an example, not as a limitation, the secret key of the token IC card is stored in the storing unit 15 of the server 10. In other words, the recorded contents of the token IC card can be rewritten only by the server 10.

The token IC card is then sent to the user A.A of the terminal 20A, as an example, not as a limitation, by mail.

The application processing unit 211 of the terminal 20A reads the received token IC card by means of the communication I/F 22 (as an example, not as a limitation, NFC card reader) of the terminal 20A and displays the cryptographic asset exchange token issuance information. When the application processing unit 211 of the terminal 20A sends the cryptographic asset exchange request information to the exchange server 40, the application processing unit 211 informs the user A.A of the terminal 20A to send the token IC card to the cryptographic asset exchange by mail, etc. The user A.A. sends the token IC card containing the cryptographic asset exchange token to the cryptographic asset exchange.

When the KYC process is performed and the cryptographic asset wallet address of the user A.A is determined, the control unit 41 of the exchange server 40 sends the cryptographic asset wallet address of the user A.A and the contents of the cryptographic asset exchange token stored in the token IC card to the server 10 by means of the communication I/F 44. The server 10 performs the cryptographic asset issuance process based on the received cryptographic asset wallet address of the user A.A and the contents of the cryptographic asset exchange token.

Here, the cryptographic asset exchange may send the token IC card from the cryptographic asset exchange to the issuing entity, and the server 10 may verify the contents before performing the cryptographic asset issuance process.

When the exchange server 40 confirms the issuance of a cryptographic asset, the token IC card is destroyed at the cryptographic asset exchange, thereby making it non-reusable.

Instead of destroying the token IC card, the token IC card may be sent from the cryptographic asset exchange to the issuing entity, and the recorded contents of the token IC card may be initialized at the server 10 to make it not reusable. In this case, the token IC card can be recycled. It means that the token IC card cannot be used by a same user, but can be recycled and used by another user.

Any functional blocks shown in the figures and described above may be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It should be understood that example embodiments described herein should be considered in a descriptive sense only and not for purposes of limitation. While some example embodiments have been particularly shown and described, it will be understood by one of ordinary skill in the art that variations in form and detail may be made therein without departing from the spirit and scope of the claims.

What is claimed is:

1. An information processing apparatus comprising:
at least one processor configured to perform,
a first process for associating first information for a user of a terminal to obtain a cryptographic asset with identification information of the user, and
a second process for associating the cryptographic asset with the identification information of the user, based on verification with respect to the user.

2. The information processing apparatus according to claim 1, wherein
the first information is
associated with at least a unit of legal currency before the first process is performed, and
associated with at least a unit of the cryptographic asset after the first process is performed.

3. The information processing apparatus according to claim 2, wherein
the first information is associated with the unit of the cryptographic asset based on an exchange rate between the legal currency and the cryptographic asset when the first process is performed.

4. The information processing apparatus according to claim 1, wherein
the first information is
associated with at least a unit of a point before the first process is performed, and
associated with at least a unit of the cryptographic asset after the first process is performed.

5. The information processing apparatus according to claim 4, wherein
the first information is associated with at least the unit of the cryptographic asset based on an exchange rate between the point and the cryptographic asset when the first process is performed.

6. The information processing apparatus according to claim 1, wherein
when the at least one processor performs the first process, the first process for associating the first information with identification information of a user, who is different from the user, is restricted.

7. The information processing apparatus according to claim 1, wherein
when the at least one processor performs the second process, the second process for associating the cryptographic asset based on the first information, which is a subject of the first process, with the identification information of the user that is a subject of the second process, is restricted.

8. The information processing apparatus according to claim 1, wherein
the first information is associated with a first blockchain, and
the cryptographic asset is associated with a second blockchain.

9. The information processing apparatus according to claim 8, wherein
the first information and the identification information of the user associated with first information are associated with the first blockchain when the first process is performed, and
the cryptographic asset based on the first information and the identification information of the user are associated with the second blockchain when the second process is performed.

10. The information processing apparatus according to claim 1, wherein
the first information is associated with a blockchain, and
the cryptographic asset is associated with the blockchain.

11. The information processing apparatus according to claim 10, wherein
the first information and the identification information of the user associated with first information are associated with the blockchain when the first process is performed, and
the cryptographic asset based on the first information and the identification information of the user are associated with the blockchain when the second process is performed.

12. A non-transitory computer-readable medium storing a program thereon, which when executed by at least one processor, cause an information processing apparatus to perform a process, the process comprising:
performing a first process for associating first information for a user of a terminal to obtain a cryptographic asset with identification information of the user; and
performing a second process for associating the cryptographic asset with the identification information of the user, in response to verification with respect to the user.

13. An information processing method in an information processing apparatus, the method comprising:
performing a first process for associating first information for a user of a terminal to obtain a cryptographic asset with identification information of the user; and
performing a second process for associating the cryptographic asset with the identification information of the user, in response to verification with respect to the user.

14. A non-transitory computer-readable medium storing a program thereon, which when executed by at least one processor, cause a terminal to perform a process, the process comprising:
displaying, on a display of the terminal, first display information based on association of first information for a user of the terminal to obtain a cryptographic asset with identification information of the user, and
displaying in response to verification with respect to the user, on the display of the terminal, second display information based on association of the cryptographic asset with the identification information of the user.

15. The medium according to claim 14, the process further comprising:
displaying on the display, information notifying to conduct the verification with respect to the user, when the first display information is displayed on the display.

16. An information processing method in a terminal comprising:
displaying, on a display of the terminal, first display information based on association of first information for a user of the terminal to obtain a cryptographic asset, with identification information of the user; and
displaying in response to verification with respect to the user, on the display of the terminal, second display information based on association of the cryptographic asset with the identification information of the user.

17. A terminal comprising:
a processor configured to control a display to display,
first display information based on association of first information for a user of the terminal to obtain a cryptographic asset with identification information of the user, and
in response to verification with respect to the user, second display information based on association of the cryptographic asset with the identification information of the user.
